(19) United States
(12) Patent Application Publication
(10) Pub. No.: US 2026/0059521 A1
(43) Pub. Date: Feb. 26, 2026

(54) MANAGING OPERATING MODE OF ACCESS POINT IN WIRELESS COMMUNICATION NETWORK

(71) Applicant: Samsung Electronics Co., Ltd., Suwon-si (KR)

(72) Inventors: Abhishek CHATURVEDI, Bengaluru (IN); Karthik Srinivasa GOPALAN, Bengaluru (IN); Manasi EKKUNDI, Bengaluru (IN)

(21) Appl. No.: 19/377,812

(22) Filed: Nov. 3, 2025

Related U.S. Application Data
(63) Continuation of application No. PCT/KR2025/011126, filed on Jul. 25, 2025.

(30) Foreign Application Priority Data
Jul. 26, 2024 (IN) 202441057048
Jun. 26, 2025 (IN) 202441057048

(51) Int. Cl. H04W 72/12; H04W 52/02; H04W 60/04; H04W 72/51

(52) U.S. Cl. CPC H04W 72/1215; H04W 52/0206; H04W 60/04; H04W 72/51

(57) ABSTRACT

A method for managing an operating mode of a serving AP includes: receiving an indication to transmit data. The serving AP is operating in one of an LCM or a HCM with a scheduled LCM. The indication to transmit data require the serving AP to perform one of switching to the HCM based on the serving AP operating in the LCM, or extending the HCM during the scheduled LCM based on the serving AP operating in the HCM. The method includes identifying a neighboring AP, based on established coordination information exchanged among the serving AP and one or more neighboring APs. The neighboring AP is operating in the HCM. The method includes performing a redirection procedure to the neighboring AP, to offload the associated client device and serve the received indication to transmit data.

### CROSS-REFERENCE TO RELATED APPLICATIONS

This application is a continuation of International Application No. PCT/KR2025/011126 designating the United States, filed on July 25, 2025, in the Korean Intellectual Property Receiving Office and claiming priority to Indian Provisional Patent Application No. 202441057048, filed on July 26, 2024, and Indian Complete Patent Application No. 202441057048, filed on June 26, 2025, in the Indian Patent Office, the disclosures of which are all incorporated by reference herein in their entireties.

### BACKGROUND

### Field

The disclosure relates to wireless communication, and for example, to systems and methods for managing an operating mode of an Access Point (AP) in a wireless communication network.

### Description of Related Art

The evolution of Institute of Electrical and Electronics Engineers (IEEE) 802.11 standards, particularly Wireless Fidelity (Wi-Fi 7) (802.11be) and the emerging Wi-Fi 8 (802.11bn), has introduced advanced mechanisms to meet the increasing demands for high throughput, low latency, and energy efficiency. In 802.11 standards, a concept of an operating mode for an Access Point (AP) has been formalized as a set of parameters that define currently supported features of the AP. These set of parameters typically include Bandwidth (BW), Number of Spatial Streams (NSS), Modulation and Coding Scheme (MCS), and other relevant settings or elements. Accordingly, the AP may have its logical reasoning and requirements for operating in a certain mode.

Further, in WiFi8 or Task Group bn (TGbn) standards, one of the functional requirements is Power Saving (PS) in the AP. Multiple schemes and solutions are being identified for PS in the AP. Accordingly, mechanisms are being developed to allow an Ultra-High Reliability (UHR) AP to dynamically transition the current operating mode of the AP between a Low Capability Mode (LCM) and a High Capability Mode (HCM). The transition in the current operating mode may happen based on certain triggers or control signaling. The LCM minimizes and/or reduces power consumption but with lower Quality of Service (QoS). On the other hand, the HCM fulfills stringent QoS needs at the cost of the AP’s power consumption. The LCM typically involves conservative configurations (e.g., 20 Mega Hertz (MHz) BW, 1 NSS, low MCS values, and simpler Physical Protocol Data Unit (PPDU) formats). On the other hand, the HCM utilizes enhanced configurations (e.g., 80 MHz BW, 4 NSS, higher MCS values, and advanced PPDU formats) to serve UHR client demands.

Wi-Fi 8 introduces a concept of multi-AP coordination. FIG. 1A is a diagram illustrating a pictorial depiction of multi-AP coordination technique 100A, in accordance with related art. FIG. 1A illustrates a plurality of APs, such as an AP1 101, an AP2 103, and an AP3 105. The AP1 101 may autonomously discover neighboring APs, such as the AP2 103 and the AP3 105 (may be collectively referred to as neighboring APs 103 and 105). Thereafter, the AP1 101 may exchange operational and PS information with the neighboring APs 103 and 105. The AP1 101 may also enter-into coordinated agreements with the neighboring APs 103 and 105. The coordinated agreements help in reducing co-channel interference and improving spectrum efficiency. The multi-AP coordination technique 100A further allows the APs 101, 103, and 105 to meet UHR performance targets. The multi-AP coordination concept 100A may define various types of schemes, including coordinated APs (C-AP), coordinated time division multiple access (C-TDMA), coordinated (restricted) target wake-up time (C-(R)TWT), coordinated beamforming (C-BF), coordinated spatial reuse (C-SR), and coordinated joint transmissions (C-JT), among others.

In roaming scenarios, a specific case of coordinated operation involves dedicated interaction between a serving AP and potential target APs. Such coordination is typically established when the APs are part of the same mobility domain. To enable a near-lossless handover of a client device between two non-collocated APs with minimal latency, the architecture commonly adopted in alignment with Wi-Fi 8 standards emphasizes enhanced context transfer mechanisms. Such transfers are facilitated either through a Common Control Entity interlinking the APs or over the backend Distribution System (DS).

Additionally, existing methods explore Multi-AP Coordination (MAPC) strategies aimed at power-saving optimization. In MAPC for AP PS, each participating AP shares its individual PS profile with a designated coordination entity or group coordinator. FIG. 1B is a diagram illustrating a pictorial depiction of MAPC for AP PS scheme 100B, in accordance with related art. As shown, in the MAPC scheme 100B, the AP1 101 may act as a group owner. The AP1 101 may receive PS Profile (PP) from each of the neighboring APs, e.g., the AP2 103 and the AP3 105, as shown by steps 102 and 104. In the MAPC scheme 100B, the coordination process around the PPs for all of the APs may involve evaluating individual PP profiles through a Negotiation Function (NF) 107. The NF 107 then derives a Negotiated Power-saving Profile (NPP) for each of the APs, e.g., the AP1 101, the AP2 103, and the AP3 105. The negotiation process takes into account various parameters such as power-saving type (scheduled or dynamic), operational modes (for example, sleep, low capability mode, high capability mode, timing offsets for PS scheme initiation, and durations for the sleep cycles). Furthermore, the negotiation process considers information related to BW, NSS, MCS, and applicable links. Accordingly, the AP1 101 shares the PPs of each of the APs with the NF 101 at step 106. In response, at step 108, the AP1 101 receives the NPP from the NF 107. Then, at steps 110 and 112, the AP1 101 shares the NPP with the AP2 103 and AP3 105, respectively. Each AP’s resulting NPP is disseminated across the group, and each AP applies its corresponding profile within its Basic Service Set (BSS). The coordinated application of optimized NPPs ensures improved power efficiency across all participating APs. Additionally, NPPs may also contain details pertaining to the next sequential PS scheme, if applicable. By adhering to these optimized profiles, APs collectively benefit from more efficient power-saving behavior while maintaining service quality and coordination integrity within the network.

However, challenges arise when an AP’s PS cycle is interrupted. FIG. 2 is a diagram illustrating an example scenario 200 of an interruption in the PS cycle of the AP, in accordance with related art. As illustrated in FIG. 2, a UHR AP 202 is connected to a first client device 204, and is operating in LCM (capability mode A 201). However, the UHR AP 202 receives an interruption signal 205 from a second client device 206 that requires a change of the operating mode from the LCM to the HCM (capability mode B 203). Therefore, the interruption signal 205 may be considered as a capability mode change request. The interruption signal 205 may be a high-priority signal, such as a time-sensitive data transmission, a low latency traffic signal (for example, a video stream), a high QoS signal (for example, voice transmission), etc. If the interruption signal 205 is not one of the high priority signal, the low latency traffic signal, or the high QoS signal, then the UHR AP 202 may deny the capability mode change request. However, if the interruption signal 205 is one of the high-priority, low-latency traffic signals, or the high QoS signal, then the UHR AP 202 may not be able to deny the capability mode change request. This is because denying the capability mode change request would prevent or suppress the UHR AP 202 from serving the incoming traffic within the required time constraints. As a result, the performance of critical services, such as real-time communication or latency-sensitive applications, would be compromised. Accordingly, the UHR AP 202 may be forced to switch to the HCM (e.g., the capability mode B 203) due to the arrival of the interruption signal 205. Thus, the power-saving operation is interrupted, and power consumption is increased.

Similarly, FIG. 3 is a diagram illustrating a scenario 300 where a UHR AP 302 is forced to extend the HCM operating mode in response to the interruption signal. As shown, the AP 302 is connected to a client device 304 and is operating in the HCM (e.g., a capability mode B 301). The AP 302 is scheduled to operate in the LCM (e.g., a capability mode A 303) at a predefined time T1. However, the AP 302 receives the interruption signal 305 before T1 from the client device 304. Accordingly, the UHR AP 302 fails to transit to the LCM and is forced to extend the HCM, resulting in higher power consumption.

The interrupting signal may originate from a client device currently served by the UHR AP or another associated client device. However, in both cases, the UHR AP may be forced to operate in the HCM, resulting in an increase in power consumption at the UHR AP.

Hence, there is a need for improved techniques that address the above-discussed and other related problems/challenges. The description set forth in the background section should not be assumed to be prior art merely because it is set forth in the background section.

### SUMMARY

According to an example embodiment, disclosed herein is a method for managing an operating mode of a serving Access Point (AP) in a wireless communication network. The method includes: receiving, at the serving AP from an associated client device, an indication to transmit data, the serving AP operating in one of a Low Capability Mode (LCM) or a High Capability Mode (HCM) with a scheduled LCM, wherein the indication to transmit data requires the serving AP to perform one of switching to the HCM based on the serving AP operating in the LCM, or extending the HCM during the scheduled LCM based on the serving AP operating in the HCM; identifying, in response to the received indication to transmit data, a neighboring AP among one or more neighboring APs, based on established coordination information exchanged among the serving AP and the one or more neighboring APs, the identified neighboring AP operating in the HCM; and performing, by the serving AP, a redirection procedure to the identified neighboring AP, to offload the associated client device and serve the received indication to transmit data.

According to an example embodiment, disclosed herein is a method for managing an operating mode of a serving Access Point (AP) in a wireless communication network. The method includes: transmitting, by an associated client device to the serving AP, an indication to transmit data, the serving AP operating in one of a Low Capability Mode (LCM) or a High Capability Mode (HCM) with a scheduled LCM, wherein the indication to transmit data requires the serving AP to perform one of switching to the HCM based on the serving AP operating in the LCM, or extending the HCM during the scheduled LCM based on the serving AP operating in the HCM; and receiving, from the serving AP, a redirect notify message in response to the transmitted indication to transmit data, wherein the redirect notify message directs the associated client device to re-associate with a neighboring AP.

According to an example embodiment, disclosed herein is a system for managing an operating mode of a serving Access Point (AP) in a wireless communication network. The system includes: a memory and at least one processor, comprising processing circuitry, wherein at least one processor is coupled, directly or indirectly, to the memory and is individually and/or collectively configured to cause the system to: receive, from an associated client device, an indication to transmit data, the serving AP operating in one of a Low Capability Mode (LCM) or a High Capability Mode (HCM) with a scheduled LCM, ,wherein the indication to transmit data requires the serving AP to perform one of switching to the HCM based on the serving AP operating in the LCM, or extending the HCM during the scheduled LCM based on the serving AP operating in the HCM; identify, in response to the received indication to transmit data, a neighboring AP among one or more neighboring APs, based on established coordination information exchanged among the serving AP and the one or more neighboring APs, the identified neighboring AP operating in the HCM; and perform a redirection procedure to the identified neighboring AP, to offload the associated client device and serve the received indication to transmit data.

According to an example embodiment, disclosed herein is a system for managing an operating mode of a serving Access Point (AP) in a wireless communication network. The system includes: a memory and at least one processor, comprising processing circuitry, wherein at least one processor is coupled to the memory and is individually and/or collectively configured to cause the system to: transmit, to the serving AP, an indication to transmit data,, the serving AP operating in one of a Low Capability Mode (LCM) or a High Capability Mode (HCM) with a scheduled LCM, wherein the indication to transmit data requires the serving AP to perform one of switching to the HCM based on the serving AP operating in the LCM, or extending the HCM during the scheduled LCM based on the serving AP operating in the HCM; and receive, from the serving AP, a redirect notify message in response to the transmitted indication to transmit data, wherein the redirect notify message directs the associated client device to re-associate with a neighboring AP.

To further clarify the advantages and features, a more particular description will be rendered by reference to various example embodiments thereof, which are illustrated in the appended drawings. It is appreciated that these drawings depict example embodiments and are therefore not to be considered limiting its scope. The disclosure will be described and explained with additional specificity and detail with the accompanying drawings.

### BRIEF DESCRIPTION OF THE DRAWINGS

These and other features, aspects, and advantages of certain embodiments of the present disclosure will be more apparent from the following detailed description, taken in conjunction with the accompanying drawings in which like characters represent like parts throughout the drawings and in which:

FIG. 1A is a diagram illustrating a pictorial depiction of a multi-Access Point (AP) coordination technique, in accordance with related art.

FIG. 1B is a diagram illustrating a pictorial depiction of Multi-AP Coordination (MAPC) for AP Power Saving(PS) scheme, in accordance with related art.

FIGS. 2 and 3 are diagrams illustrating example scenarios of interruption in Power Saving (PS) cycle of an AP, in accordance with related art.

FIG. 4 is a diagram illustrating an example wireless communication network that supports managing an operating mode of a serving AP in the wireless communication network, according to various embodiments.

FIG. 5 is a block diagram illustrating an example configuration of a system for managing the operating mode of a serving AP, according to various embodiments.

FIG. 6 is a diagram illustrating an example scenario for identifying a neighboring AP among one or more neighboring APs, according to various embodiments.

FIG. 7 is a diagram illustrating an example scenario depicting the handling of an indication to transmit data when the serving AP is operating in the LCM, according to various embodiments.

FIG. 8 is a diagram illustrating an example scenario depicting the handling of the indication to transmit data when the serving AP is operating in the HCM, according to various embodiments.

FIG. 9 is a diagram illustrating an example scenario explaining the Transition Time (TT) for offloading the associated client device, according to various embodiments.

FIGS. 10, 11 and 12 are signal flow diagrams illustrating examples of performing the redirection procedure, according to various embodiments.

FIG. 13 is a block diagram illustrating an example configuration of a system for managing the operating mode of the serving AP in the wireless communication network, according to various embodiments.

FIGS. 14 and 15 are flowcharts illustrating example methods for managing the operating mode of the serving AP in the wireless communication network, according to various embodiments.

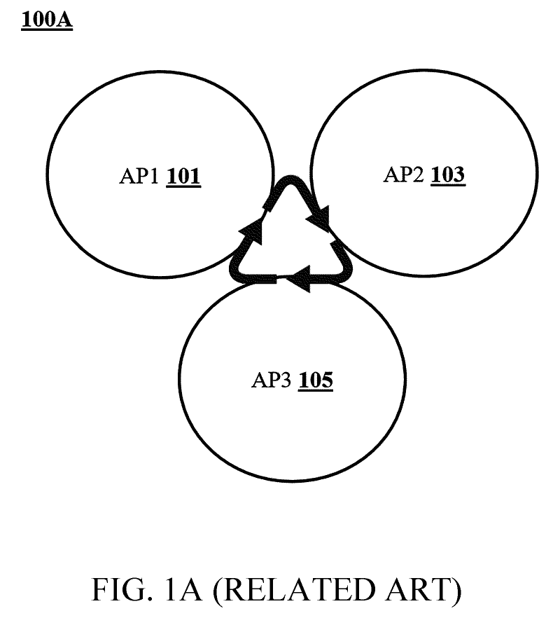

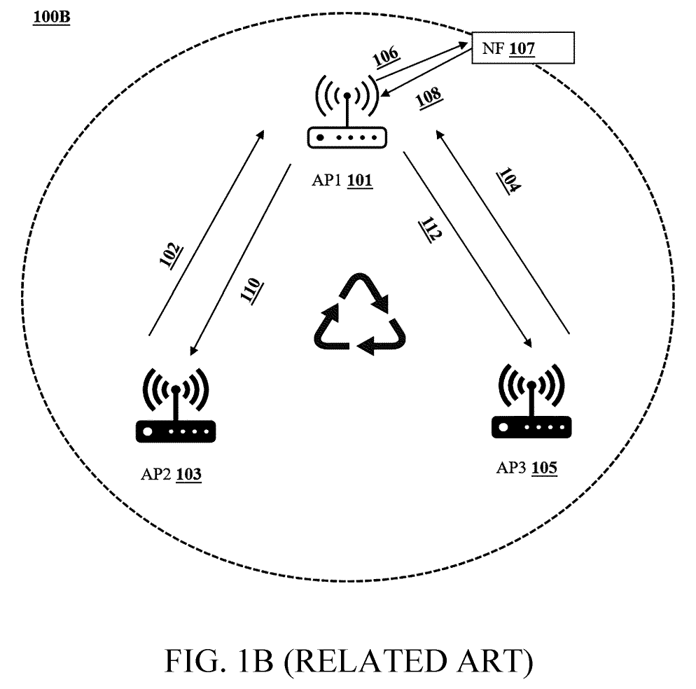

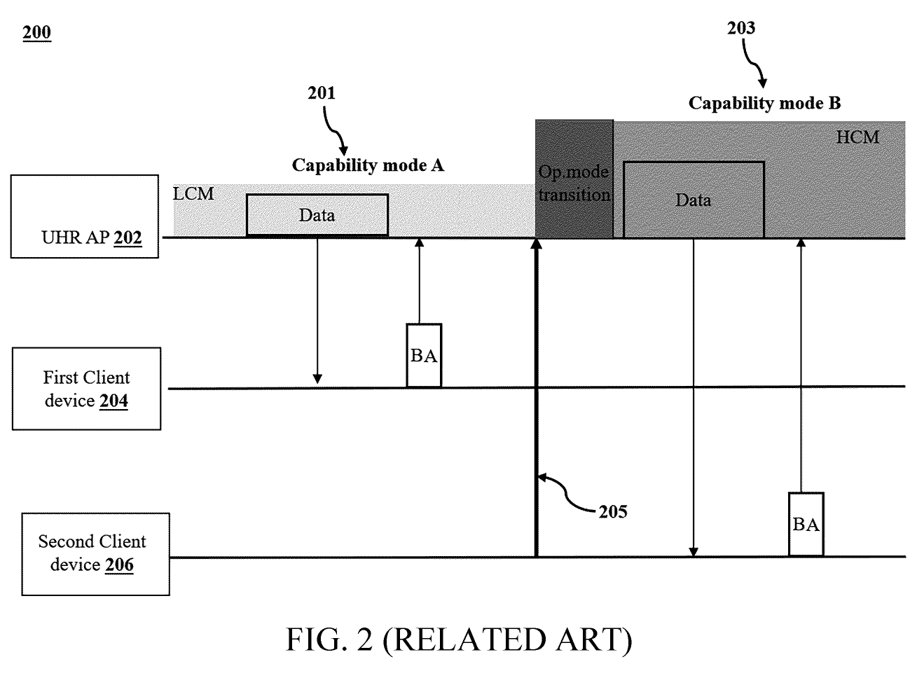

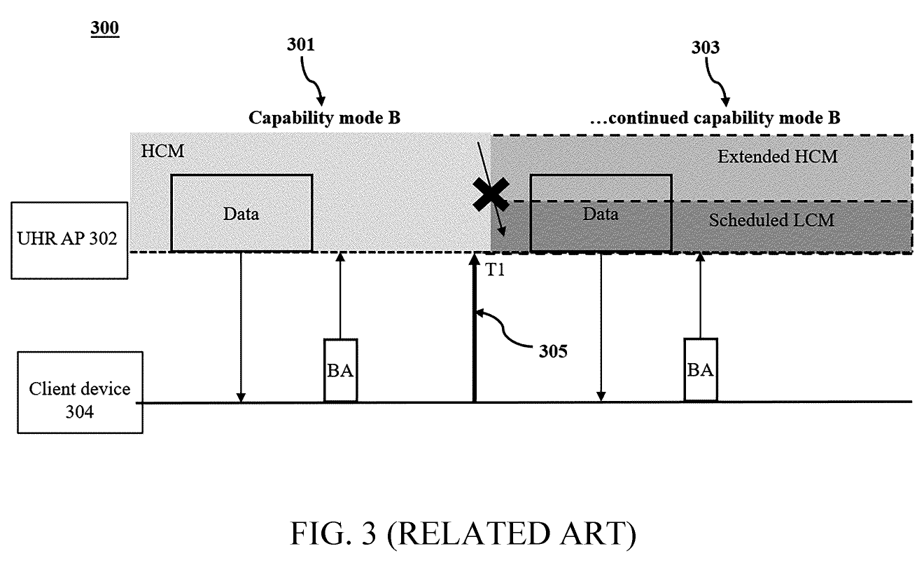

Further, skilled artisans will appreciate that those elements in the drawings are illustrated for simplicity and may not have necessarily been drawn to scale. For example, the flowcharts illustrate the method to help to improve understanding of aspects of the present disclosure. Furthermore, in terms of the construction of the device, one or more components of the device may have been represented in the drawings by conventional symbols, and the drawings may show those specific details that are pertinent to understanding the embodiments of the present disclosure so as not to obscure the drawings with details that will be readily apparent to those of ordinary skill in the art having the benefit of the description herein.

### DETAILED DESCRIPTION

Reference will now be made to various example embodiments, and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as "one or more features" or "one or more elements" or "at least one feature" or "at least one element." Furthermore, the use of the terms "one or more" or "at least one" feature or element does not preclude there being none of that feature or element, unless otherwise specified by limiting language including, but not limited to, "there needs to be one or more…" or "one or more elements is required."

Reference is made herein to various "embodiments." It should be understood that an embodiment is an example of a possible implementation of any features and/or elements of the present disclosure. Various embodiments have been described for the purpose of explaining one or more of the potential ways in which the specific features and/or elements of the disclosure fulfill the requirements of uniqueness, utility, and/or the like.

Use of the phrases and/or terms including, but not limited to, "a first embodiment," "a further embodiment," "an alternate embodiment," "one embodiment," "an embodiment," "multiple embodiments," "some embodiments," "other embodiments," "further embodiment", "furthermore embodiment", "additional embodiment" or other variants thereof do not necessarily refer to the same embodiments. Unless otherwise specified, one or more particular features and/or elements described in connection with various embodiments may be found in an embodiment, or may be found in more than one embodiment, or may be found in all embodiments, or may be found in no embodiments. Although one or more features and/or elements may be described herein in the context of a single embodiment, or in the context of more than one embodiment, or in the context of all embodiments, the features and/or elements may instead be provided separately or in any appropriate combination or not at all. Any features and/or elements described in the context of separate embodiments may alternatively be realized as existing together in the context of a single embodiment.

Any particular and all details set forth herein are used in the context of various embodiments and therefore should not necessarily be taken as limiting factors to the disclosure.

The terms "comprises", "comprising", or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by "comprises... a" does not, without more constraints, preclude the existence of other devices or other sub-systems or other elements or other structures or other components or additional devices or additional sub-systems or additional elements or additional structures or additional components.

The term "couple" and the derivatives thereof refer to any direct or indirect communication between two or more elements, whether or not those elements are in physical contact with each other. The terms "transmit", "receive", and "communicate" as well as the derivatives thereof encompass both direct and indirect communication. The term "or" is an inclusive term including "and/or". The phrase "associated with," as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term "controller" may refer to any device, system, or part thereof that controls at least one operation. The functionality associated with any particular controller may be centralized or distributed, whether locally or remotely. The phrase "at least one of," when used with a list of items, may refer to different combinations of one or more of the listed items being used, and only one item in the list may be needed. For example, "at least one of A, B, and C" includes any of the following combinations: A, B, C, A and B, A and C, B and C, and A and B and C, and any variations thereof. As an additional example, the expression "at least one of a, b, or c" may indicate only a, only b, only c, both a and b, both a and c, both b and c, all of a, b, and c, or variations thereof. Similarly, the term "set" may refer to one or more. Accordingly, the set of items may be a single item or a collection of two or more items. The phrase "one or more of," when used with a list of items, may refer, for example, to different combinations of one or more of the listed items may be used, and only one item in the list may be needed. For example, "one or more of: A, B, of C" includes any of the following combinations: A, B, C, A and B, A and C, B and C, and A and B and C.

Moreover, multiple functions described below may be implemented or supported by one or more computer programs, each of which is formed from computer readable program code and embodied in a computer readable medium. The terms "application" and "program" may refer to one or more computer programs, software components, sets of instructions, procedures, functions, objects, classes, instances, related data, or a portion thereof adapted for implementation in a suitable computer readable program code. The phrase "computer readable program code" includes any type of computer code, including source code, object code, and executable code. The phrase "computer readable medium" includes any type of medium capable of being accessed by a computer, such as Read Only Memory (ROM), Random Access Memory (RAM), a hard disk drive, a Compact Disc (CD), a Digital Video Disc (DVD), or any other type of memory. A "non-transitory" computer readable medium excludes wired, wireless, optical, or other communication links that transport transitory electrical or other signals. A non-transitory computer readable medium includes media where data may be permanently or semi-permanently stored and media where data may be stored and later overwritten, such as a rewritable optical disc or an erasable memory device.

The present disclosure discloses techniques to manage the capability mode of an Access Point (AP) in Ultra-High Reliability (UHR) Wireless-Fidelity (Wi-Fi) networks. In an embodiment, the disclosed techniques may use multi-AP coordination and Power-Saving (PS) schemes to allow an AP to intelligently handle data transmission demands without unnecessary transitions from Low Capability Mode (LCM) to High Capability Mode (HCM) or extension of ongoing HCM operation (with scheduled LCM). An AP uses shared information from trusted neighbor APs. The information may include, but is not limited to, power profiles, Physical (PHY) layer capabilities, session details, and security information. The AP can offload interrupting or high-priority traffic to a nearby AP using the information received from the trusted neighbor APs. Accordingly, the disclosed techniques avoid switching to or extending the HCM, save energy, and maintain service quality. The disclosed techniques also support optimized signaling and context transfer for smooth offloading.

Various example embodiments of the present disclosure will be described in greater below with reference to the accompanying drawings.

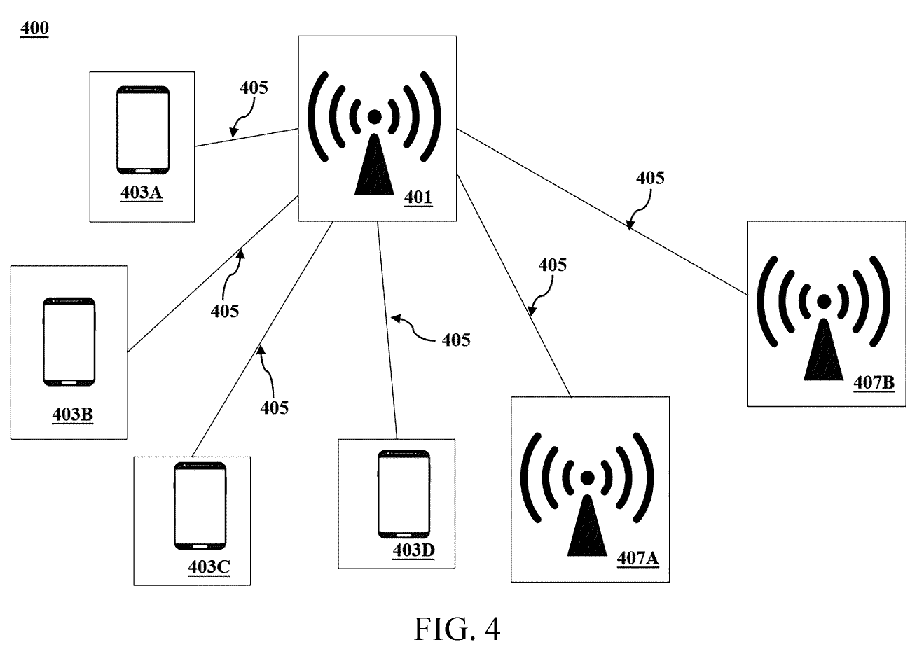

FIG. 4 is a diagram illustrating an example wireless communication network 400, according to various embodiments. In an embodiment, the wireless communication network 400 may correspond to a Wi-Fi network capable of supporting UHR, such as Wi-Fi 8 and higher Wi-Fi networks. The wireless communication network 400 may include an Access Point (AP) (also referred to as a serving AP 401) connected, directly or indirectly, to a plurality of client devices 403A, 403B, 403C, 403D (also referred to as the associated client devices 403) and one or more neighboring APs, such as AP 407A and AP 407B (also referred to as the neighboring APs 407). The serving AP 401 may serve as a central wireless node that facilitates network connectivity by bridging the associated user devices 403 with a wired or core network infrastructure (not shown). The serving AP 401 may include, but is not limited to, transceivers, antennas, processing circuitry, and software logic to manage wireless traffic, authenticate users, and allocate radio resources.

The associated client devices 403 may be any wireless-enabled terminals or nodes. The associated client devices 403 may be dispersed throughout the coverage area of the wireless communication network 400, and each of the associated client devices 403 may be stationary, mobile, or both at different times. The associated client devices 403 may be devices in different forms or having different capabilities.

Further, the associated client devices 403 may include or may be referred to as a station (STA), a wireless device, a remote device, a handheld device, a subscriber device, or some other suitable terminology, where the "device" may also be referred to as a unit, a station, a terminal, or a client, among other examples. The associated client devices 403 may also include or may be referred to as a personal electronic device, such as a cellular phone, a Personal Digital Assistant (PDA), a tablet computer, a laptop computer, or a personal computer. In some examples, the associated client devices 403 may include or be referred to as a wireless local loop (WLL) station, an Internet of Things (IoT) device, an Internet of Everything (IoE) device, or a machine-type communications (MTC) device, among other examples, which may be implemented in various objects such as appliances, or vehicles, meters, among other examples. Further, each of the associated client devices 403 may be capable of establishing a wireless connection with the serving AP 401 via one or more communication links 405.

Each of the neighboring APs 407 may be capable of establishing a wireless connection with the serving AP 401 via the one or more communication links 405. The one or more communication links 405 may represent active wireless communication paths established between the serving AP 401 and the associated client devices 403. The one or more communication links 405 may operate according to one or more wireless communication standards, such as IEEE 802.11 (e.g., 802.11n, 802.11ac, 802.11ax, 802.11be, 802.11bn). The one or more communication links 405 may support various data rates, frequency bands, and modulation schemes. The one or more communication links 405 may facilitate bidirectional transmission of data packets, management frames, and control signals.

In various examples, each of the one or more communication links 405 may be dynamically adapted based on signal quality, network congestion, or device capabilities to optimize performance and maintain connectivity.

In an embodiment, the serving AP 401 and the neighboring APs 407 may be part of a group of trusted APs. The group of trusted APs may be formed under any scheme for Power Saving (PS), such as multi-AP coordination (MAPC) scheme. A group of trusted Access Points (APs) typically refers to APs that are affiliated with the same backend domain, such as those within a Seamless Mobility Domain (SMD), a Fast Transition (FT) domain, or an enterprise network. Since these APs operate under the same domain, their inter-AP authentication, communication, and configuration are considered secure and trustworthy. This contrasts with communication between two unrelated APs, where one could potentially be a rogue or malicious AP.

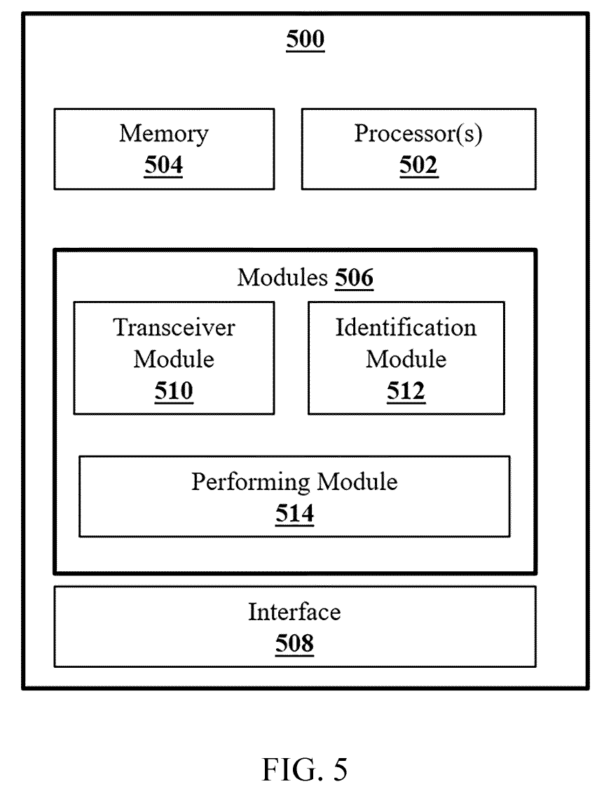

FIG. 5 is a block diagram illustrating an example configuration of a system 500 for managing an operating mode of a serving AP (for example, the serving AP 401), according to various embodiments. In an embodiment, the system 500 may correspond to the serving AP 401. FIG. 5 has been explained in conjunction with FIG. 4 for the sake of brevity of the disclosure.

The system 500 may include one or more processors (e.g., including processing circuitry) 502 (hereinafter referred to as the processor 502), a memory 504, one or more modules (e.g., including various circuitry and/or executable program instructions) 506, and an interface 508 comprising interface circuitry. In an example embodiment, the one or more processors 502 may be operatively coupled, directly or indirectly, to the memory 504, the modules 506, and the interface 508. Each "module" and "unit" herein may comprise circuitry.

In an embodiment, the processor 502 comprising processing circuitry may include at least one data processor for executing processes in a Virtual Storage Area Network. The processor 502 may include specialized processing units such as integrated system (bus) controllers, memory management control units, floating point units, graphics processing units, digital signal processing units, etc. In an embodiment, the processor 502 may include a Central Processing Unit (CPU), a Graphics Processing Unit (GPU), or both. The processor 502 may be one or more general processors, Digital Signal Processors (DSPs), application-specific integrated circuits, Field-Programmable Gate Arrays (FPGAs), servers, networks, digital circuits, analog circuits, combinations thereof, or other now known or later developed devices for analyzing and processing data. The processor 502 may execute a software program, such as code generated manually (e.g., programmed) to perform the desired operation. The processor 502 may implement various techniques, such as, but not limited to, image processing, data extraction, Artificial Intelligence (AI), Machine Learning (ML), Deep Learning (DL), and so forth, to achieve the desired objective.

In an embodiment, the processor 502 may be configured to perform the functions of the system 500 or the AP 401.

The processor 502 may be disposed in communication with one or more Input/Output (I/O) devices, such as the associated client device 403, via the interface 508. The interface 508 may employ communication Code-Division Multiple Access (CDMA), High-Speed Packet Access (HSPA+), Global System For Mobile Communications (GSM), Long-Term Evolution (LTE), WiMax, or the like, etc. Each "processor" herein includes processing circuitry, and/or may include multiple processors. For example, as used herein, including the claims, the term "processor" may include various processing circuitry, including at least one processor, wherein one or more of at least one processor, individually and/or collectively in a distributed manner, may be configured to perform various functions described herein. As used herein, when "a processor", "at least one processor", and "one or more processors" are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 502 can include processing circuitry, which can be implemented by a circuit, for example a system on chip (SoC) or an integrated circuit (IC). The processor 602 may include the combination of one or more processors such as a CPU, GPU, MPU, an application processor (AP), and a communication processor (CP).

In an embodiment, the processor 502 may be disposed in communication with a communication network via a network interface. In an embodiment, the network interface may be the interface 508. The network interface may connect to the communication network to enable connection of the system 500 with the outside environment and/or device/system. The network interface may employ connection protocols, including, without limitation, direct connect, Ethernet (e.g., twisted pair 10/100/1000 Base T), Transmission Control Protocol/Internet Protocol (TCP/IP), token ring, IEEE 802.11/b/g/n/x, etc. The communication network may include, without limitation, a direct interconnection, Local Area Network (LAN), Wide Area Network (WAN), wireless network (e.g., using Wireless Application Protocol (WAP), the Internet, etc. Using the network interface and the communication network, the system 500 may communicate with other devices. The network interface may employ connection protocols including, but not limited to, direct connect, Ethernet (e.g., twisted pair 10/100/1000 Base T), TCP/IP, token ring, IEEE 802.11/b/g/n/x, etc.

The memory 504 may be communicatively coupled, directly or indirectly, to the processor 502. The memory 504 may be configured to store data and instructions executable by the processor 502. In an embodiment, the memory 504 may communicate via a bus within the system 500. The memory 504 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 504 may include a cache or random-access memory for the processor 502. In alternative examples, the memory 504 is separate from the processor 502, such as a cache memory of a processor, the system memory, or other memory. The memory 504 may be an external storage device or database for storing data. The memory 504 may be operable to store instructions executable by the processor 502. The functions, acts, or tasks illustrated in the figures or described may be performed by the programmed processor 502 for executing the instructions stored in the memory 504. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like. The memory 504 may further include a database to store the data. Further, the memory 504 may include an operating system for performing one or more tasks of the system 500, as performed by a generic operating system in the communications domain. The memory 504 stores instructions that, when executed by at least one processor individually or collectively, cause the system 500, which can be an AP, to perform the methods and/or the operations described herein. The at least one processor may include the combination of one or more processors such as the processor 502, the transceiving circuitry in the transceiver module 510, the processing circuitry in the identification module 512, the processing circuitry in the performing module 514, a CPU, GPU, MPU, an application processor (AP), and a communication processor (CP). The processing circuitry in the prediction module 610 may be included in the processor 602. The transceiving circuitry in the transceiver module 510 may be included in the processor 502. The processing circuitry in the identification module 512 may be included in the processor 502. The processing circuitry in the performing module 514 may be included in the processor 502.

For the sake of brevity, the architecture and standard operations of the processor 502 and the memory 504 are not discussed in detail. In an embodiment, the memory 504 may be configured to store the information as required by the processor 502 to perform the techniques described herein.

The modules 506, amongst other things, may include routines, programs, objects, components, data structures, etc., which perform particular tasks or implement data types. The modules 506 may also be implemented as signal processor(s), state machine(s), logic circuits, and/or any other device or component that manipulates signals based on operational instructions.

Further, the modules 506 can be implemented in hardware, instructions executed by a processing unit, or by a combination thereof. The processing unit can comprise a computer, the processor 502, a state machine, a logic array, or any other suitable device capable of processing instructions. The processing unit can be a general-purpose processor that executes instructions to cause the general-purpose processor to perform the required tasks, or the processing unit can be dedicated to performing the required functions. In some examples of the present disclosure, the modules 506 may be machine-readable instructions (software) that, when executed by a processor/processing unit, perform any of the described functionalities. Furthermore, the data serves, amongst other things, as a repository for storing data processed, received, and generated by one or more of the modules. The modules 506 may include a transceiver module 510, an identification module 512, and a performing module 514. In an embodiment, the modules 506 may be configured to perform one or more operations of the system 500 and/or the processor 502. Each such module may include processing circuitry, which can be implemented by a circuit, for example a system on chip (SoC) or an integrated circuit (IC). Each such module can be controlled by the processor(s) 502.

Referring back to FIG. 4, the serving AP 401 is connected to one of the associated client devices 403, such as the associated client device 403A. The serving AP 401 may be operating in one of a Low Capability Mode (LCM) or a High Capability Mode (HCM) with a scheduled LCM. The LCM is a power-efficient mode with reduced performance, while the HCM provides higher performance at the cost of increased power consumption. Accordingly, the serving AP 401 may operate in the LCM. The serving AP 401 may also operate in the HCM with the scheduled LCM. Accordingly, even if the serving AP 401 is currently operating in the HCM, the serving AP 401 may switch to the more energy-efficient LCM at a predetermined time to conserve power.

Referring again to FIG. 5, the processor 502 and/or the transceiver module 510, comprising transceiving circuitry, may be configured to receive an indication to transmit data from the associated client device 403A. The indication to transmit data may correspond to one of a high priority, a Low Latency (LL) traffic, and a higher Quality of Service (QoS) data transmission. If the serving AP 401 is operating in the LCM, the indication to transmit data may require the serving AP to switch to the HCM. However, when the serving AP 401 is operating in the HCM with the scheduled HCM, the indication to transmit may require the serving AP to extend the HCM during the scheduled LCM.

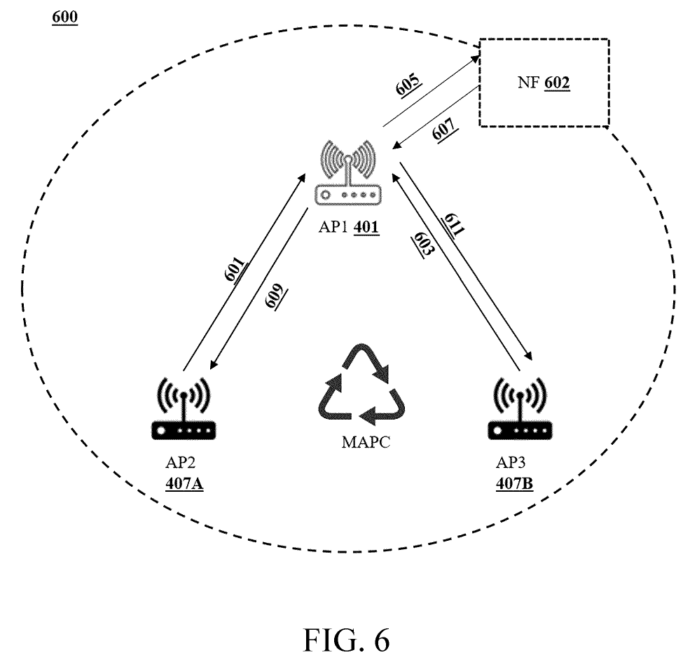

In response to the received indication to transmit data, the processor 502 and/or the identification module 512 may be configured to identify a neighboring AP, such as the AP 407A among the one or more neighboring APs 407. The identification module 512 may be configured to identify the neighboring AP 407A based on pre-established coordination information exchanged among the serving AP 401 and the one or more neighboring APs 407. It should be noted that the identified neighboring AP 407A is operating in the HCM. In an embodiment, the pre-established coordination information may include a Negotiated Power-Saving Profile (NPP) shared among the one or more neighboring APs. The NPP may include, but is not limited to, a power-saving duration associated with each of the APs among the one or more neighboring APs 407, a power-saving scheme associated with each of the APs among the one or more neighboring APs 407, and radio/physical layer capabilities associated with each of the APs among the one or more neighboring APs 407. In an embodiment, the identification module 512 may identify the neighboring AP 407A, as defined in reference to FIG. 6.

FIG. 6 is a diagram illustrating an example scenario for identifying a neighboring AP (for example, the neighboring AP 407A) among the neighboring APs 407, according to various embodiments. In an embodiment, the APs 401, 407A, and 407B may be a part of the PS scheme, such as the MAPC scheme. Accordingly, the AP1 401 may act as the group owner or coordinator AP 401. The coordinator AP 401 may receive PS Profile (PP) from each of the neighboring APs, e.g., AP2 407A and AP3 407B, through steps 601 and 603. In an embodiment, an NF 602 may negotiate the PPs for all of the APs 401, 407A, and 407B. The NF 602 then derives the NPP for each of the APs, e.g., AP1 401, AP2 407A, and AP3 407B. The negotiation process takes into account various parameters such as power-saving type (scheduled or dynamic), operational modes (for example, sleep, light control sleep, heavy control sleep, timing offsets for PS scheme initiation, and durations for the sleep cycles). The negotiation process may consider information related to BW, NSS, MCS, and applicable links. Accordingly, the serving AP 401 shares the PPs of each of the APs with the NF 602, at step 605. In response, at step 607, the serving AP 401 receives the NPP from the NF 602. Then, at steps 609 and 611, the serving AP 401 shares the NPP with the neighboring APs, e.g., AP2 407A and AP3 407B, respectively. Each AP’s resulting NPP is disseminated across the group, and each AP applies its corresponding profile within its Basic Service Set (BSS). The identification module 512 may then identify the neighboring AP based on the NPP. In an embodiment, the serving AP 401 may identify the neighboring AP based on a current operating configuration of the neighboring AP, current load of the neighboring AP and traffic requirements of the associated client device 403A. For example, let us assume that both of the neighboring APs 407A and 407B are operating in HCM. However, the neighboring AP 407B has a higher load than the neighboring AP 407A. Accordingly, the identification module 512 may identify the neighboring AP 407A as the neighboring AP to offload the associated client device 403A. Similarly, in another example, the neighboring AP 407B may not be able to meet the traffic requirements of the associated client device 403A. Accordingly, the identification module 512 may identify the neighboring AP 407A as the neighboring AP to offload the associated client device 403A. However, if the neighboring AP 407A is not operating in the HCM, but the neighboring AP 407B is operating in the HCM. Then, the identification module 512 may identify the neighboring AP 407B as the neighboring AP to offload the associated client device 403A.

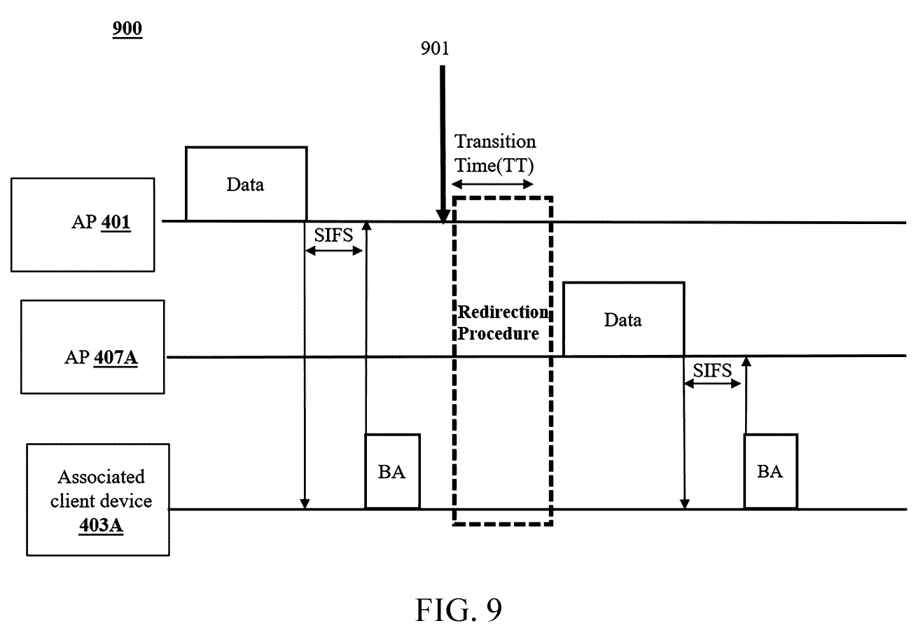

Referring back to FIG. 5, the performing module 514 may be configured to perform a redirection procedure to the identified neighboring AP 407A, to offload the associated client device 403A and serve the received indication to transmit data. In an embodiment, the performing module 514 may be configured to perform the redirection procedure within a Transition Time (TT). In an example embodiment, the TT may be less than a predetermined threshold. In an example embodiment, the predetermined threshold may be pre-configured, such as less than or equal to an optimal UHR roaming scenario time duration. Accordingly, TT may be defined as the shortest time duration within which the serving AP 401 may process the redirection procedure. It is important to complete the entire redirection procedure within TT to ensure that the associated client device 403A is able to quickly get re-associated with the neighboring AP 407A and resume data flow to minimize and/or reduce the data flow interruption. The TT is explained in greater detail below with reference to FIG. 9.

In an embodiment, in order to perform the redirection procedure, the processor 502 and/or the performing module 514 may be configured to transmit a redirect indication message to the identified neighboring AP 407A. In response, the performing module 514 may be configured to receive a redirect confirmation message from the identified neighboring AP 407A. Then, the performing module 514 may be configured to transmit a redirect notify message to the associated client device 403A. The redirect notify message may indicate the associated client device 403A to re-associate with the identified neighboring AP 407A and transmit the data to the identified neighboring AP 407A, in response to the received redirect confirmation message.

In an embodiment, the redirect indication message may include, but is not limited to, a coordination group Identifier (ID), a reason code for redirection, and information associated with the associated client device 403A. The coordination group ID may correspond to an ID that confirms both APs, e.g., the serving AP 401 and the neighboring AP 407A, belonging to a form of coordinated/affiliated/ trusted group based on any coordination scheme known in the art. The reason code for redirection may indicate a reason for offloading the associated client device 403A from the serving AP 401 to the neighboring AP 407A, such as "forced_HCM_trans", "forced_HCM_ext", etc. Further, the information associated with the associated client device 403A may include capability information and Quality of Service (QoS) requirements. The capability information may indicate capability support for links, Number of Spatial Streams (NSS), Modulation and Coding Scheme (MCS), Bandwidth (BW), etc. The QoS requirements may indicate the QoS requirements of the ongoing data session of the associated client device 403A.

In an embodiment, the redirect confirmation message may include, but is not limited to, a coordination group Identifier (ID) and a response to the redirect indication message. The coordination group ID may reciprocate the same ID, e.g., the coordination group ID in the redirect indication message. Accordingly, the coordination group ID may confirm both APs, e.g., the serving AP 401 and the neighboring AP 407A, belonging to the form of coordinated/affiliated/trusted group based on any coordination scheme known in the art. The response to the redirect indication message may indicate a response of the neighboring AP 407A to the redirect indication message. The response may indicate acceptance or rejection of the offloading request. The neighboring AP 407A may determine the response using information associated with the associated client device 403A shared by the serving AP 401 and based on the ability of the neighboring AP 407A to support required QoS, client or traffic load on the neighboring AP 407A, etc.

In an embodiment, the redirect notify message may include, but is not limited to, a neighbor ID associated with the identified neighboring AP 407A, available link information of the identified neighboring AP 407A, and a timing of broadcasting a beacon of the identified neighboring AP 407A. The neighbor ID may indicate the ID of the neighboring AP 407A. The available link information may indicate available link(s) as confirmed by the neighboring AP 407A to the serving AP 401 in the redirect confirmation message. The timing of broadcasting may be used to read the Basic Service Set (BSS) broadcast of the neighboring AP 407A quickly. Alternatively, in an embodiment, the serving AP 401 may include an unsolicited probe response in the redirect notify message.

In an embodiment, when the redirection procedure is successful, the performing module 514 may be configured to continue the LCM or switch to the scheduled LCM after an expiry of a predefined time period associated with the HCM. In particular, if the serving AP 401 is operating in the LCM, then after successful completion of the redirection procedure, the serving AP 401 may continue to operate in the LCM. However, if the serving AP 401 is operating in the HCM with the scheduled LCM, then after successful completion of the redirection procedure, the serving AP 401 may switch to the scheduled LCM after the expiry of the predefined time period.

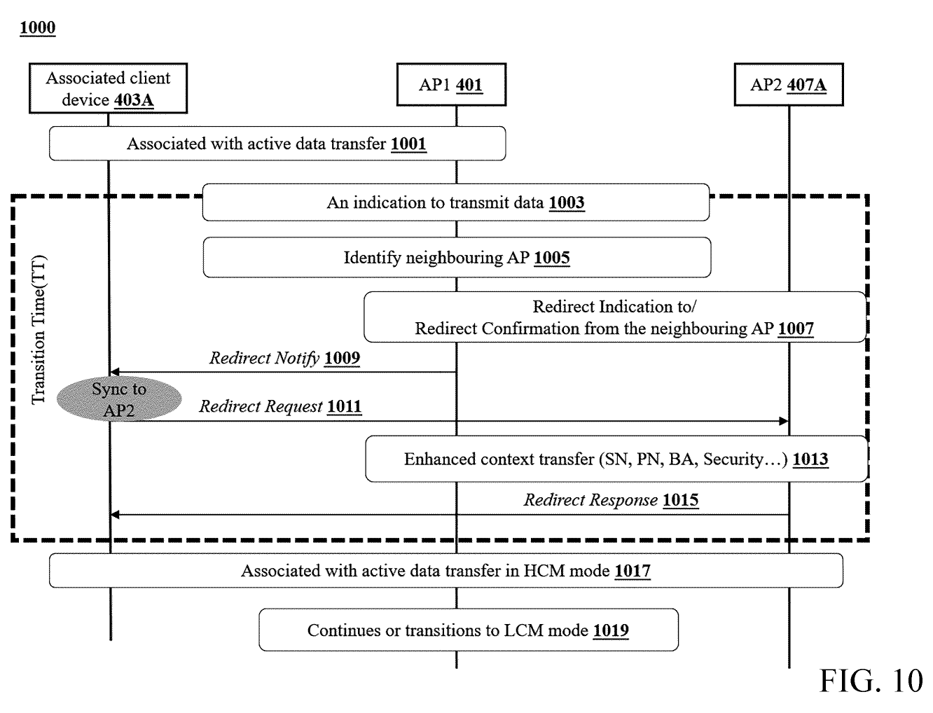

In an embodiment, when the redirection procedure is successful, the performing module 514 may be configured to transmit current data session context of the associated client device 403A to the identified neighboring AP 407A. In an embodiment, the current data session context may include, but is not limited to, a Sequence Number (SN) associated with a current data session, a Packet Number (PN) per Traffic Identifier (TID) associated with the current data session, a Block Acknowledgement (BA) agreement associated with the current data session, and security keys associated with the current data session. The redirection procedure has been further explained in detail in reference to FIGS. 10-12.

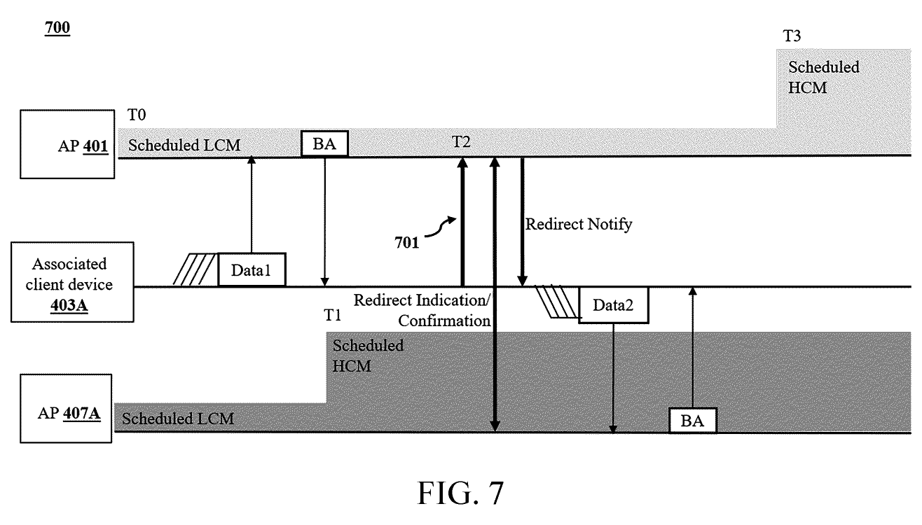

FIG. 7 is a diagram illustrating an example scenario 700 depicting the handling of the indication to transmit data when the serving AP 401 is operating in the scheduled LCM, according to various embodiments. As shown, the serving AP 401 and the identified neighboring AP 407A are operating in coordination under the MAPC for AP PS. The serving AP 401 has been operating in the LCM since T0. The serving AP 401 is connected to the associated client device 403A. Accordingly, the serving AP 401 may receive a data request, e.g., for DATA1, from the associated client device 403A. In response, the serving AP 401 may transmit a Block Acknowledgement (BA) message to the associated client device 403A and serve the associated client device 403A. The serving AP 401 is scheduled to operate in the HCM at time T3. However, at time T2, the serving AP 401 receives the indication to transmit data 701 from the associated client device 403A. It should be noted that the serving AP 401 may receive the indication to transmit data 701 from any of the associated client devices 403, such as any one of the associated client devices 403B-403D. The indication to transmit data 701 may force the serving AP 401 to move to a non-scheduled HCM mode at time T2. However, in an embodiment, instead of switching to the HCM, the serving AP 401 may identify a neighboring AP, such as the neighboring AP 407A, that is already operating in the HCM prior to time T2, such as since time T1. In an embodiment, the serving AP 401 may identify the neighboring AP 407A in accordance with techniques discussed in reference to FIGS. 5 and 6. Accordingly, the serving AP 401 may perform the redirection procedure in accordance with the techniques described herein. For example, the serving AP 401 may transmit the redirect indication message to the neighboring AP 407A. In response, the serving AP 401 may receive the redirect confirmation message from the neighboring AP 407A. Further, the serving AP 401 may transmit the redirect notify message to the associated client device 403A. After the successful completion of the redirection procedure, the now serving AP 407A may receive a data request, e.g., for DATA2, from the associated client device 403A. In response, the now serving AP 407A may transmit a BA message to the associated client device 403A and serve the associated client device 403A. As shown, the previous serving AP 401 continues to operate in the LCM, thus managing the power saving efficiently.

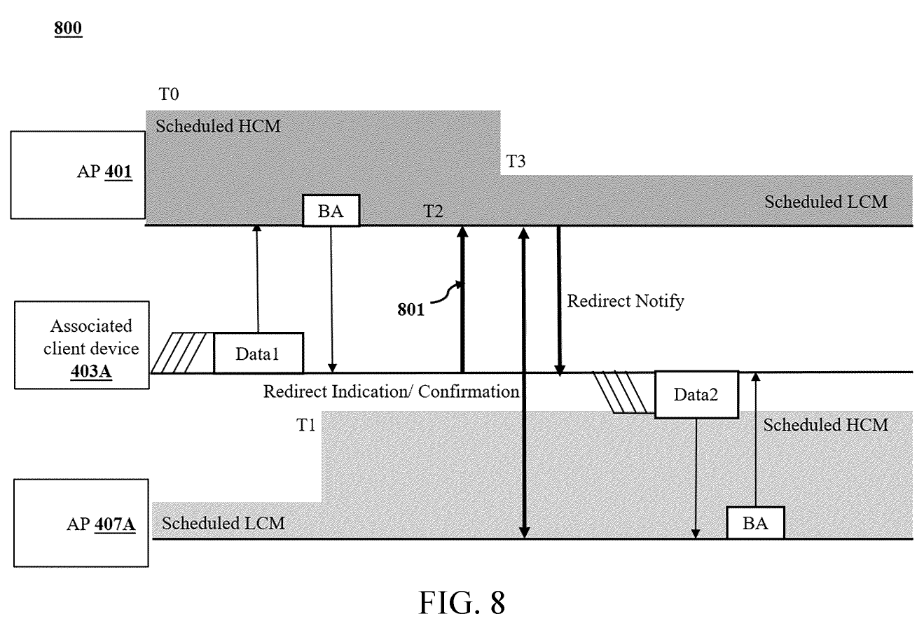

FIG. 8 is a diagram illustrating an example scenario 800 depicting the handling of the indication to transmit data when the serving AP 401 is operating in the scheduled HCM, according to various embodiments. As shown, the serving AP 401 and the identified neighboring AP 407A are operating in coordination under the MAPC for AP PS. The serving AP 401 has been operating in the HCM since T0, with an LCM scheduled at a pre-defined time period, such as T3. The serving AP 401 is connected to the associated client device 403A. Accordingly, the serving AP 401 may receive a data request, e.g., for DATA1, from the associated client device 403A. In response, the serving AP 401 may transmit a Block Acknowledgement (BA) message to the associated client device 403A and serve the associated client device 403A. The serving AP 401 is scheduled to operate in the LCM at time T3. However, at time T2, the serving AP 401 receives the indication to transmit data 801 from the associated client device 403A. It should be noted that the serving AP 401 may receive the indication to transmit data 801 from any of the associated client devices 403, such as any one of the associated client devices 403B-403D. The indication to transmit data 801 may force the serving AP 401 to extend the operation in HCM mode. However, in an embodiment, instead of extending the HCM, the serving AP 401 may identify a neighboring AP, such as the neighboring AP 407A, that is already operating in the HCM prior to time T2, such as since time T1. In an embodiment, the serving AP 401 may identify the neighboring AP 407A in accordance with techniques discussed in reference to FIGS. 5-6. Accordingly, the serving AP 401 may perform the redirection procedure in accordance with the techniques described herein. For example, the serving AP 401 may transmit the redirect indication message to the neighboring AP 407A. In response, the serving AP 401 may receive the redirect confirmation message from the neighboring AP 407A. Further, the serving AP 401 may transmit the redirect notify message to the associated client device 403A. After the successful completion of the redirection procedure, the now serving AP 407A may receive a data request, e.g., for DATA2 from the associated client device 403A. In response, the now serving AP 407A may transmit a BA message to the associated client device 403A and serve the associated client device 403A. As shown, the previous serving AP 401 may switch to the LCM at the pre-defined time period, such as T3.

FIG. 9 is a diagram illustrating an example scenario 900 explaining the Transition Time (TT) for offloading the associated client device 403A, according to various embodiments. The TT may be defined as the shortest time duration within which the serving AP 401 may process the complete redirection procedure. It is important to complete the redirection procedure within the TT to ensure that the associated client device 403A is able to quickly get re-associated and resume the data flow to minimize and/or reduce the data flow interruption. As shown, the associated client device 403A is connected to the serving AP 401 using techniques known in the art. For example, the associated client device 403A is connected to the serving AP 401 and is in an ongoing data transmission via the DATA message and the BA message. The TT may start upon receiving the indication to transmit data 901. By the end of the TT, the associated client device 403A has re-associated with the neighboring AP 407A successfully, with a data session context established. In an embodiment, the value of the TT may be either less than or equal to an optimal UHR roaming scenario time duration, such as 1 Millisecond (ms). In various examples, the operating mode change delay for the serving AP 401 may also be considered as a boundary value for the TT duration. The operating mode change delay may refer to a padding delay in dedicated or broadcast signaling.

FIGS. 10, 11 and 12 are signal flow diagrams 1000, 1100, and 1200, respectively, illustrating examples for performing the redirection procedure, according to various embodiments.

Referring to FIG. 10, at operation 1001, the associated client device 403A is associated with the serving AP 401 and is in active data transmission. However, at operation 1003, the serving AP 401 may receive the indication to transmit data. Then, at operation 1005, the serving AP 401 may identify the neighboring AP, such as AP 407A, among the neighboring APs 407A and 407B. It should be noted that the serving AP 401 may identify the neighboring AP 407A in accordance with techniques discussed in reference to FIGS. 4, 5 and 6. The serving AP 401 may perform the redirection procedure. Accordingly, at operation 1007, the serving AP 401 may trigger a ‘Redirect Indication/Redirect Confirmation’ with the neighboring AP 407A. At operation 1009, the serving AP 401 may transmit the Redirect Notify message to the associated client device 403A. At operation 1011, the associated client device 403A may transmit a ‘Redirect Request’ message to the neighboring AP 407A to initiate data handover, including a ‘Link Reconfiguration Request’. In an embodiment, the Link Reconfiguration Request’ may be an enhanced Link Reconfiguration Request including link(s) requested as received via the Redirect Notify message, to initiate re-association with the neighboring AP 407A. Then, at operation 1013, the serving AP 401 may transmit the current data session context of the associated client device 403A to the neighboring AP 407A. The current data context may include, but is not limited to, SN, PN per TID, BA agreement, and security keys associated with the current data session. In response, at operation 1015, the neighboring AP 407A may transmit a "Redirect Response" message to the associated client device 403A to conclude the data handover. The "Redirect Response" message may include a "Link Reconfiguration Response". Accordingly, at operation 1017, the associated client device 403A may get associated with the neighboring AP 407A and in active data transmission in the HCM. At operation 1019, the previous serving AP 401 continues in the LCM or transitions to the LCM for scheduled PS.

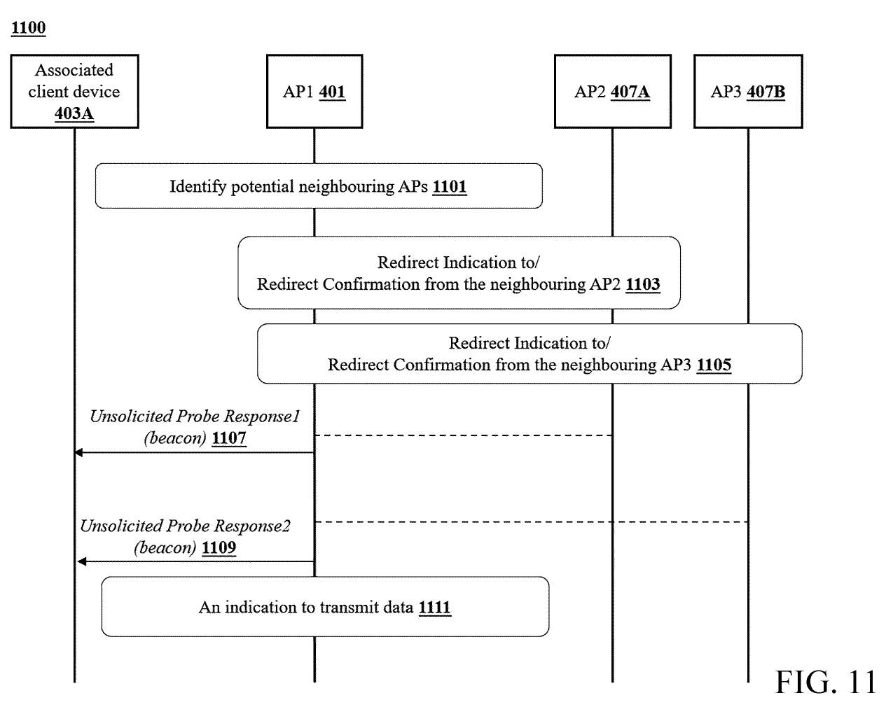

In an embodiment, the serving AP 401 may be configured to pre-process the redirect indication message and the redirect confirmation message with potential neighboring APs among the one or more neighboring APs, as shown in FIG. 11. The serving AP 401 may pre-process the redirect indication message and the redirect confirmation message before receiving the indication to transmit data. As shown in FIG. 11, at operation 1101, the serving AP 401 may identify the potential neighboring APs, such as AP 407A and AP 407B. It should be noted that the serving AP 401 may identify the potential neighboring APs in accordance with techniques discussed in reference to FIGS. 4-6. At operation 1103, the serving AP 401 may trigger the "Redirect Indication/Redirect Confirmation" with the potential neighboring AP 407A. At operation 1105, the serving AP 401 may trigger the "Redirect Indication/Redirect Confirmation" with the potential neighboring AP 407B. As a result of the pre-processing, in an embodiment at operation 1107, the serving AP 401 may pre-save the potential neighboring AP 407A’s Unsolicited Probe Response (beacon broadcast information) at the associated client device 403A.pre-process the redirect indication message and the redirect confirmation message with the potential neighboring APs, e.g., AP 407A and AP 407B. In an embodiment at operation 1109, the serving AP 401 may pre-save the potential neighboring AP 407B’s Unsolicited Probe Response (beacon broadcast information) at the associated client device 403A. Accordingly, in an embodiment, the associated client device 403A may pre-save the beacon or unsolicited probe response information of the neighboring APs. At operation 1111, the serving AP 401 may receive the indication to transmit data. Accordingly, the serving AP 401 may redirect the associated client device 403A to one of the potential neighboring APs, e.g., AP 407A and AP 407B. Further, the associated client device 403A does not need to read the broadcast of the corresponding neighboring AP. Accordingly, the techniques described in reference to FIG. 11 result in further reduction in processing time, message size and latency associated with the signaling of the redirection procedure.

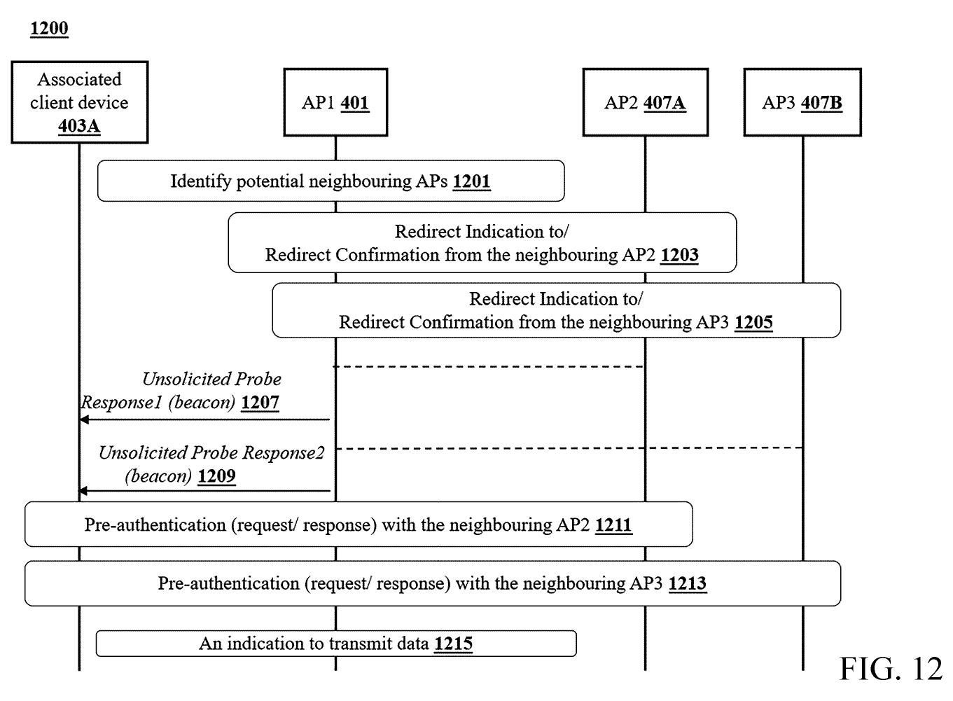

In an embodiment, the serving AP 401 may be configured to pre-authenticate the associated client device 403A with at least one AP from among the one or more neighboring APs 407, as shown in FIG. 12. As can be noticed in FIG. 12, operations 1201 to 1209 are similar to operations 1101 to 1109. Hence, the explanation of the operations 1201 to 1209 may not be repeated here for the sake of brevity of the disclosure. At operation 1211, the serving AP 401 may pre-authenticate the associated client device 403A with the potential neighboring AP 407A using techniques known in the art. At operation 1213, the serving AP 401 may pre-authenticate the associated client device 403A with the potential neighboring AP 407B using techniques known in the art. At operation 1215, the serving AP 401 may receive the indication to transmit data. Accordingly, the serving AP 401 may redirect the associated client device 403A to one of the potential neighboring APs, e.g., AP 407A and AP 407B, without the need for additional authentication steps. Accordingly, the techniques described in reference to FIG. 12 result in further reduction in processing time, message size and latency associated with the signaling of the redirection procedure.

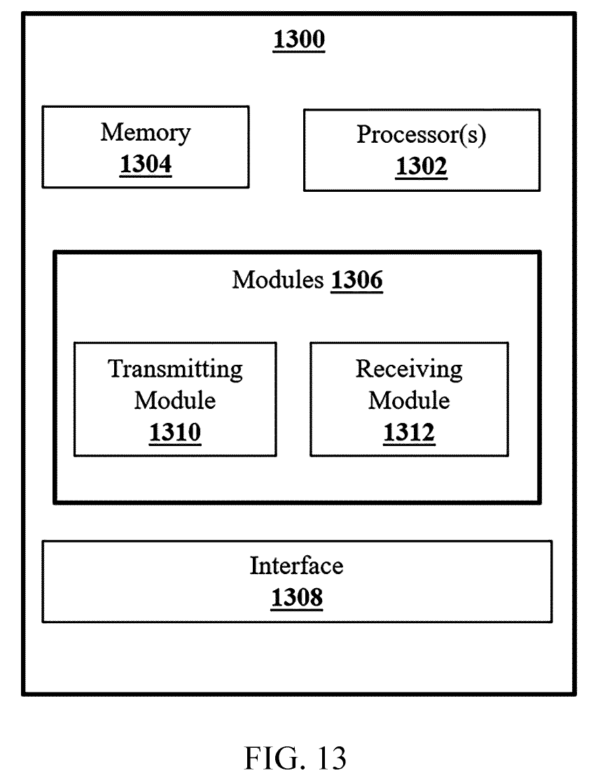

FIG. 13 is a block diagram illustrating an example configuration of a system 1300 for managing the operating mode of the AP in the wireless communication network, accordikng to various embodiments. In an embodiment, the system 1300 may correspond to any of the associated client devices (e.g. stations (STAs) among the associated client devices 403, such as the associated client device 403A. The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA.

The system 1300 may include one or more processors (e.g., including processing circuitry) 1302 (hereinafter referred to as the processor 1302), a memory 1304, one or more modules (e.g., including various circuitry and/or executable program instructions) 1306, and an interface 1308 comprising interface circuitry. In an example embodiment, the one or more processors 1302 may be operatively coupled, directly or indirectly, to the memory 1304, the modules 1306, and the interface 1308. Each "module" and "unit" herein may comprise circuitry.

In an embodiment, the processor 1302, comprising processing circuitry, may include at least one data processor for executing processes in a Virtual Storage Area Network. The processor 1302 may include specialized processing units such as integrated system (bus) controllers, memory management control units, floating point units, graphics processing units, digital signal processing units, etc. In an embodiment, the processor 1302 may include a Central Processing Unit (CPU), a Graphics Processing Unit (GPU), or both. The processor 1302 may be one or more general processors, Digital Signal Processors (DSPs), application-specific integrated circuits, Field-Programmable Gate Arrays (FPGAs), servers, networks, digital circuits, analog circuits, combinations thereof, or other now known or later developed devices for analyzing and processing data. The processor 1302 may execute a software program, such as code generated manually (e.g., programmed) to perform the desired operation. The processor 1302 may implement various techniques, such as, but not limited to, image processing, data extraction, Artificial Intelligence (AI), Machine Learning (ML), Deep Learning (DL), and so forth, to achieve the desired objective.

In an embodiment, the processor 1302 may be configured to perform the functions of the system 1300 or the associated client device 403A.

The processor 1302 may be disposed in communication with one or more Input/Output (I/O) devices, such as the associated client devices 403, via the interface 1308. The interface 1308 may employ communication Code-Division Multiple Access (CDMA), High-Speed Packet Access (HSPA+), Global System For Mobile Communications (GSM), Long-Term Evolution (LTE), WiMax, or the like, etc. Each "processor" herein includes processing circuitry, and/or may include multiple processors. For example, as used herein, including the claims, the term "processor" may include various processing circuitry, including at least one processor, wherein one or more of at least one processor, individually and/or collectively in a distributed manner, may be configured to perform various functions described herein. As used herein, when "a processor", "at least one processor", and "one or more processors" are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 1302 can include processing circuitry, which can be implemented by a circuit, for example a system on chip (SoC) or an integrated circuit (IC). The processor 1302 may include the combination of one or more processors such as a CPU, GPU, MPU, an application processor (AP), and a communication processor (CP).

In an embodiment, the processor 1302 may be disposed in communication with a communication network via a network interface. In an embodiment, the network interface may be the interface 1308. The network interface may connect to the communication network to enable connection of the system 1300 with the outside environment and/or device/system. The network interface may employ connection protocols, including, without limitation, direct connect, Ethernet (e.g., twisted pair 10/100/1000 Base T), Transmission Control Protocol/Internet Protocol (TCP/IP), token ring, IEEE 802.11/b/g/n/x, etc. The communication network may include, without limitation, a direct interconnection, Local Area Network (LAN), Wide Area Network (WAN), wireless network (e.g., using Wireless Application Protocol (WAP), the Internet, etc. Using the network interface and the communication network, the system 1300 may communicate with other devices. The network interface may employ connection protocols including, but not limited to, direct connect, Ethernet (e.g., twisted pair 10/100/1000 Base T), TCP/IP, token ring, IEEE 802.11/b/g/n/x, etc.

The memory 1304 may be communicatively coupled, directly or indirectly, to the processor 1302. The memory 1304 may be configured to store data and instructions executable by the processor 1302. In an embodiment, the memory 1304 may communicate via a bus within the system 1300. The memory 1304 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 1304 may include a cache or random-access memory for the processor 1302. In alternative examples, the memory 1304 is separate from the processor 1302, such as a cache memory of a processor, the system memory, or other memory. The memory 1304 may be an external storage device or database for storing data. The memory 1304 may be operable to store instructions executable by the processor 1302. The functions, acts, or tasks illustrated in the figures or described may be performed by the programmed processor 1302 for executing the instructions stored in the memory 1304. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like. The memory 1304 may further include a database to store the data. Further, the memory 1304 may include an operating system for performing one or more tasks of the system 1300, as performed by a generic operating system in the communications domain. The memory 1304 stores instructions that, when executed by at least one processor individually or collectively, cause the system 1300, which can be an AP, to perform the methods and/or the operations described herein. The at least one processor may include the combination of one or more processors such as the processor 1302, the transmitting circuitry in the transmitting module 1310, the receiving circuitry in the receiving module 1312, a CPU, GPU, MPU, an application processor (AP), and a communication processor (CP). The transmitting circuitry in the transmitting module 1310 may be included in the processor 1302. The receiving circuitry in the receiving module 1312 may be included in the processor 1302.

For the sake of brevity, the architecture and standard operations of the processor 1302 and the memory 1304 are not discussed in detail. In an embodiment, the memory 1304 may be configured to store the information as required by the processor 1302 to perform the techniques described herein.

The modules 1306, amongst other things, include routines, programs, objects, components, data structures, etc., which perform particular tasks or implement data types. The modules 1306 may also be implemented as signal processor(s), state machine(s), logic circuits, and/or any other device or component that manipulates signals based on operational instructions. The modules 1306 may be configured to one or more operations of the system 1300 and/or the processor 1302.

Further, the modules 1306 can be implemented in hardware, instructions executed by a processing unit, or by a combination thereof. The processing unit can comprise a computer, the processor 1302, a state machine, a logic array, or any other suitable device capable of processing instructions. The processing unit can be a general-purpose processor that executes instructions to cause the general-purpose processor to perform the required tasks, or the processing unit can be dedicated to performing the required functions. In some examples, the modules 1306 may be machine-readable instructions (software) that, when executed by a processor/processing unit, perform any of the functionalities described. Furthermore, the data serves, amongst other things, as a repository for storing data processed, received, and generated by one or more of the modules. The modules 1306 may include a transmitting module 1310, and a receiving module 1312. Each such module may include processing circuitry, which can be implemented by a circuit, for example a system on chip (SoC) or an integrated circuit (IC). Each such module can be controlled by the processor(s) 1302.

In an embodiment, the transmitting module 1310, comprising transmitting circuitry, may be configured to transmit, to the serving AP 401, the indication to transmit data. The indication to transmit data may correspond to one of the high priority, the Low Latency (LL) traffic, and the higher Quality of Service (QoS) data transmission. If the serving AP 401 is operating in the LCM, the indication to transmit data may require the serving AP to switch to the HCM. However, when the serving AP 401 is operating in the HCM with the scheduled HCM, the indication to transmit may require the serving AP to extend the HCM during the scheduled LCM. It should be noted that the indication to transmit data may correspond to the indication to transmit data as explained in reference to FIGS. 4-9. Hence, the details of the indication to transmit data may not be repeated here for the sake of brevity of the disclosure.

In response, the receiving module 1312, comprising receiving circuitry, may be configured to receive the redirect notify message from the serving AP 401. It should be noted that the redirect notify message may correspond to the redirect notify message as explained in reference to FIGS. 4-9. Hence, the details of the redirect notify message have been omitted here for the sake of brevity of the disclosure. Further, in response, the transmitting module 1312 may be configured to transmit the redirect request message to the neighboring AP 407A. In an embodiment, the redirect request message may comprise the request to initiate the data handover session with the neighboring AP 407A, as explained in reference to FIG. 10. Hence, the details of the same have been omitted here for the sake of brevity of the disclosure. In response, the receiving module 1310 may be configured to receive the redirect response message from the neighboring AP 407A. The redirect response message may indicate at least a confirmation of the data handover session, as explained in reference to FIG. 10. Hence, the details of the same have may not be repeated here for the sake of brevity of the disclosure.

In an embodiment, the system 1300 may be configured to pre-save the beacon or the unsolicited probe response information of the neighboring AP 407A in the memory 1304, as explained in reference to FIG. 11. Hence, the details of the same have been omitted here for the sake of brevity of the disclosure.

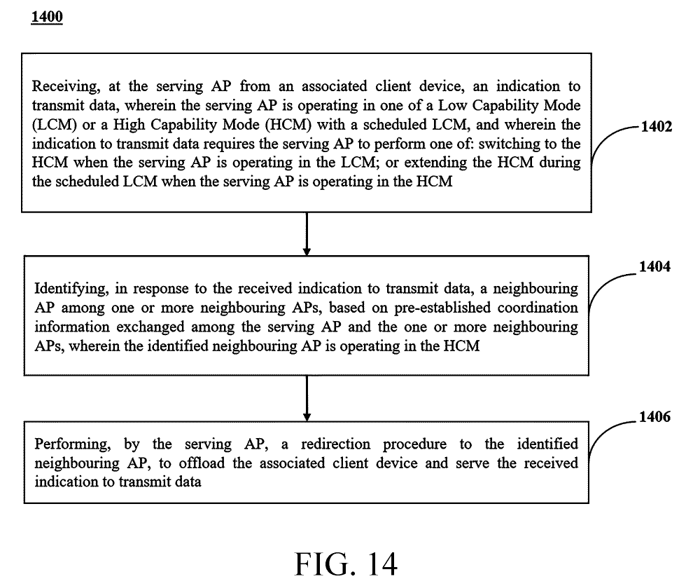

FIG. 14 is a flowchart illustrating an example method 1400 for managing the operating mode of the serving AP 401 in the wireless communication network, according to various embodiments. As shown, at operation 1402, the method 1400 may include receiving, at the serving AP 401 from an associated client device 403A, an indication to transmit data. The serving AP 401 is operating in one of the LCM or the HCM with the scheduled LCM. The indication to transmit data may require the serving AP 401 to perform one of switching to the HCM when the serving AP 401 is operating in the LCM, or extending the HCM during the scheduled LCM when the serving AP 401 is operating in the HCM. At operation 1404, the method 1400 may include identifying, in response to the received indication to transmit data, the neighboring AP 407A among one or more neighboring APs 407, based on pre-established coordination information exchanged among the serving AP 401 and the one or more neighboring APs 407. The identified neighboring AP is operating in the HCM. At operation 1406, the method 1400 may include performing, by the serving AP 401, the redirection procedure to the identified neighboring AP 407A, to offload the associated client device 403A and serve the received indication to transmit data.

While the above-discussed steps in FIG. 14 are shown and described in a particular sequence, the steps may occur in variations to the sequence in accordance with various examples/modifications. Further, a detailed description related to the various steps of FIG. 14 is already covered in the description related to FIGS. 4-12 and may not be repeated here for the sake of brevity.

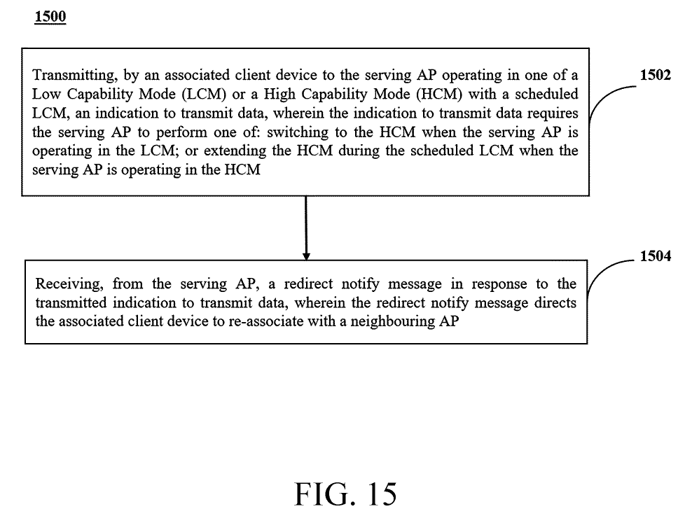

FIG. 15 is a flowchart illustrating an example method 1500 for managing the operating mode of the serving AP 401 in the wireless communication network, according to various embodiments. As shown, at operation 1502, the method 1500 may include transmitting, by the associated client device 403A to the serving AP 401, an indication to transmit data. The serving AP 401 is operating in one of the LCM or the HCM with the scheduled LCM. The indication to transmit data requires the serving AP 401 to perform one of switching to the HCM when the serving AP 401 is operating in the LCM, or extending the HCM during the scheduled LCM when the serving AP 401 is operating in the HCM. At operation 1504, the method 1500 may include receiving, from the serving AP 401, the redirect notify message in response to the transmitted indication to transmit data. The redirect notify message directs the associated client device 403A to re-associate with the neighboring AP 407A.

While the above-discussed steps in FIG. 15 are shown and described in a particular sequence, the steps may occur in variations to the sequence in accordance with various examples/modifications. Further, a detailed description related to the various steps of FIG. 15 is already covered in the description related to FIGS. 4-13 and may not be repeated herein for the sake of brevity.

An example aspect of the present disclosure provides a client device. The client device (1300) comprises at least one processor (1302) including processing circuitry. The client device (1300) comprises memory (1304) storing instructions that, when executed by the at least one processor (1302) individually or collectively, cause the client device to transmit, to a serving access point (AP) operating in one of a Low Capability Mode (LCM) or a High Capability Mode (HCM) with a scheduled LCM, an indication to transmit data. The indication to transmit data requires the serving AP to perform one of: (1) switching to the HCM when the serving AP is operating in the LCM, or (2) extending the HCM during the scheduled LCM when the serving AP is operating in the HCM. The instructions, when executed by the at least one processor (1302) individually or collectively, cause the client device to receive, from the serving AP, a redirect notify message in response to the transmitted indication to transmit data. The redirect notify message directs the client device (1300) to re-associate with a neighboring AP.

In an example embodiment, the client device is a station in a wireless network.

In an example embodiment, the instructions, when executed by the at least one processor (1302) individually or collectively, cause the client device to pre-save beacon or unsolicited probe response information of the neighboring AP at the client device.

In an example embodiment, the instructions, when executed by the at least one processor (1302) individually or collectively, cause the client device to transmit a redirect request message to the neighboring AP in response to receiving the redirect notify message. The redirect request message comprises a request to initiate a data handover session with the neighboring AP.

In an example embodiment, the instructions, when executed by the at least one processor (1302) individually or collectively, cause the client device to receive, from the neighboring AP, a redirect response message in response to the transmitted redirect request message. The redirect response message indicates at least a confirmation of the data handover session.

An example aspect of the present disclosure provides a serving access point (AP) (500). The serving AP (500) comprises at least one processor (502) including processing circuitry. The serving AP (500) comprises memory (504) storing instructions that, when executed by the at least one processor (502) individually or collectively, cause the serving AP (500) to receive, from a client device (1300) associated with the serving AP (500), an indication to transmit data. The serving AP is operating in one of a Low Capability Mode (LCM) or a High Capability Mode (HCM) with a scheduled LCM. The indication to transmit data requires the serving AP to perform one of: (1) switch to the HCM when the serving AP is operating in the LCM, or (2) extend the HCM during the scheduled LCM when the serving AP is operating in the HCM. The instructions, when executed by the at least one processor (502) individually or collectively, cause the serving AP (500) to identify, in response to receiving the indication to transmit data, a neighboring AP among one or more neighboring APs, based on pre-established coordination information exchanged among the serving AP and the one or more neighboring APs, wherein the neighboring AP is operating in the HCM. The instructions, when executed by the at least one processor (502) individually or collectively, cause the serving AP (500) to perform a redirection procedure to the identified neighboring AP, to offload the associated client device and serve the received indication to transmit data.

In an example embodiment, to perform the redirection procedure, the instructions, when executed by the at least one processor (502) individually or collectively, cause the serving AP (500) to transmit, to the identified neighboring AP, a redirect indication message. The instructions, when executed by the at least one processor (502) individually or collectively, cause the serving AP (500) to receive, from the identified neighboring AP, a redirect confirmation message in response to the transmitted redirect indication message. The instructions, when executed by the at least one processor (502) individually or collectively, cause the serving AP (500) to transmit, to the client device, a redirect notify message indicating the client device to re-associate with the identified neighboring AP and transmit the data to the identified neighboring AP, in response to the receiving the redirect confirmation message.

In an example embodiment, in response to a successful redirection procedure, the instructions, when executed by the at least one processor (502) individually or collectively, cause the serving AP (500) to perform one of: (1) continue the LCM, or (2) switch to the scheduled LCM after an expiry of a predefined time period associated with the HCM.

In an example embodiment, the instructions, when executed by the at least one processor (502) individually or collectively, cause the serving AP (500) to perform the redirection procedure within a transition time, wherein the transition time is less than a predetermined threshold.

In an example embodiment, in response to a successful redirection procedure, the instructions, when executed by the at least one processor (502) individually or collectively, cause the serving AP (500) to transmit current data session context of the associated client device to the identified neighboring AP. The current data session context includes at least one of a Sequence Number (SN) associated with a current data session, a Packet Number (PN) per Traffic Identifier (TID) associated with the current data session, a Block Acknowledgement (BA) agreement associated with the current data session, or security keys associated with the current data session.

In an example embodiment, the instructions, when executed by the at least one processor (502) individually or collectively, cause the serving AP (500) to pre-authenticate the client device with at least one AP from among the one or more neighboring APs.

In an example embodiment, the serving AP and the one or more neighboring APs are part of a group of trusted APs.

In an example embodiment, the instructions, when executed by the at least one processor (502) individually or collectively, cause the serving AP (500) to pre-process a redirect indication message and a redirect confirmation message between the serving AP and potential neighboring APs among the one or more neighboring APs before receiving the indication to transmit data.

In an example embodiment, the instructions, when executed by the at least one processor (502) individually or collectively, cause the serving AP (500) to identify the neighboring AP from among the one or more neighboring APs based on a current operating configuration of the neighboring AP, current load of the neighboring AP and traffic requirements of the associated client device.

In an example embodiment, the pre-established coordination information includes a Negotiated Power-saving Profile (NPP) shared among the one or more neighboring APs.

In an example embodiment, the NPP comprises at least one of: a power saving duration associated with each of the APs among the one or more neighboring APs, a power saving scheme associated with each of the APs among the one or more neighboring APs, or radio/physical layer capabilities associated with each of the APs among the one or more neighboring APs.

In an example embodiment, the redirect indication message includes at least one of: a coordination group identifier, a reason code for redirection, or information associated with the associated client device.

In an example embodiment, the redirect confirmation message includes at least one of: a coordination group identifier or a response to the redirect indication message.

In an example embodiment, the redirect notify message includes at least one of a neighbor ID associated with the identified neighboring AP, available link information of the identified neighboring AP, or a timing of broadcasting a beacon of the identified neighboring AP.

An example aspect of the present disclosure provides a method performed by a client device in a wireless network. The method comprises transmitting, to a serving access point (AP) operating in one of a Low Capability Mode (LCM) or a High Capability Mode (HCM) with a scheduled LCM, an indication to transmit data. The serving AP is associated with the client device. The indication to transmit data requires the serving AP to perform one of: (1) switching to the HCM when the serving AP is operating in the LCM, or (2) extending the HCM during the scheduled LCM when the serving AP is operating in the HCM. The method comprises receiving (1504), from the serving AP, a redirect notify message in response to the transmitted indication to transmit data. The redirect notify message directs the associated client device to re-associate with a neighboring AP.

In an example embodiment, the method comprises pre-saving beacon or unsolicited probe response information of the neighboring AP at the associated client device.

In an example embodiment, the method comprises transmitting a redirect request message to the neighboring AP in response to the received redirect notify message. The redirect request message comprises a request to initiate a data handover session with the neighboring AP.

In an example embodiment, method comprises receiving, from the neighboring AP, a redirect response message in response to the transmitted redirect request message. The redirect response message indicates at least a confirmation of the data handover session.

An example aspect of the present disclosure provides a method performed by a serving access point (AP) in a wireless network. The method comprises receiving, from a client device associated with the serving AP, an indication to transmit data, wherein the serving AP is operating in one of a Low Capability Mode (LCM) or a High Capability Mode (HCM) with a scheduled LCM. The indication to transmit data requires the serving AP to perform one of: (1) switching to the HCM when the serving AP is operating in the LCM, or (2) extending the HCM during the scheduled LCM when the serving AP is operating in the HCM. The method comprises identifying (1404), in response to the received indication to transmit data, a neighboring AP among one or more neighboring APs, based on pre-established coordination information exchanged among the serving AP and the one or more neighboring APs. The identified neighboring AP is operating in the HCM. The method comprises performing (1406) a redirection procedure to the identified neighboring AP, to offload the associated client device and serve the received indication to transmit data.

In an example embodiment, the redirection procedure comprises transmitting a redirect indication message to the identified neighboring AP. The redirection procedure comprises receiving, from the identified neighboring AP, a redirect confirmation message in response to the transmitted redirect indication message. The redirection procedure comprises transmitting, to the associated client device, a redirect notify message indicating the associated client device to re-associate with the identified neighboring AP and transmit the data to the identified neighboring AP, in response to the received redirect confirmation message.

In an example embodiment, in response to a successful redirection procedure, the method comprises performing one of: (1) continuing the LCM, or (2) switching to the scheduled LCM after an expiry of a predefined time period associated with the HCM.

In an example embodiment, the performing the redirection procedure comprises performing the redirection procedure within a transition time, wherein the transition time is less than a predetermined threshold.

In an example embodiment, in response to a successful redirection procedure, the method comprises transmitting current data session context of the associated client device to the identified neighboring AP. The current data session context includes at least one of a Sequence Number (SN) associated with a current data session, a Packet Number (PN) per Traffic Identifier (TID) associated with the current data session, a Block Acknowledgement (BA) agreement associated with the current data session, or security keys associated with the current data session.

In an example embodiment, the method comprises pre-authenticating the associated client device with at least one AP from among the one or more neighboring APs.

In an example embodiment, the serving AP and the one or more neighboring APs are part of a group of trusted APs.

In an example embodiment, the method comprises pre-processing a redirect indication message and a redirect confirmation message between the serving AP and potential neighboring APs among the one or more neighboring APs before receiving the indication to transmit data.

In an example embodiment, the identifying the neighboring AP comprises identifying the neighboring AP from among the one or more neighboring APs based on a current operating configuration of the neighboring AP, current load of the neighboring AP and traffic requirements of the associated client device.

In an example embodiment, the pre-established coordination information includes a Negotiated Power-saving Profile (NPP) shared among the one or more neighboring APs.

In an example embodiment, the NPP comprises at least one of: a power saving duration associated with each of the APs among the one or more neighboring APs, a power saving scheme associated with each of the APs among the one or more neighboring APs, or radio/physical layer capabilities associated with each of the APs among the one or more neighboring APs.

In an example embodiment, the redirect indication message includes at least one of: a coordination group identifier, a reason code for redirection, or information associated with the associated client device.

In an example embodiment, the redirect confirmation message includes at least one of: a coordination group identifier or a response to the redirect indication message.

In an example embodiment, the redirect notify message includes at least one of: a neighbor ID associated with the identified neighboring AP, available link information of the identified neighboring AP, or a timing of broadcasting a beacon of the identified neighboring AP.

An example aspect of the present disclosure provides a non-transitory computer-readable storage medium. The methods disclosed herein can be performed by one or more computer programs stored on the non-transitory computer-readable storage.

An example aspect of the present disclosure provides a non-transitory computer-readable storage medium storing one or more computer programs comprising instructions to perform a method for wireless communication performed by a client device. The method comprises transmitting, to a serving access point (AP) operating in one of a Low Capability Mode (LCM) or a High Capability Mode (HCM) with a scheduled LCM, an indication to transmit data. The serving AP is associated with the client device. The indication to transmit data requires the serving AP to perform one of: (1) switching to the HCM when the serving AP is operating in the LCM, or (2) extending the HCM during the scheduled LCM when the serving AP is operating in the HCM. The method comprises receiving (1504), from the serving AP, a redirect notify message in response to the transmitted indication to transmit data. The redirect notify message directs the associated client device to re-associate with a neighboring AP.

An example aspect of the present disclosure provides a non-transitory computer-readable storage medium storing one or more computer programs comprising instructions to perform a method for wireless communication performed by a serving access point (AP). The method comprises receiving, from a client device associated with the serving AP, an indication to transmit data, wherein the serving AP is operating in one of a Low Capability Mode (LCM) or a High Capability Mode (HCM) with a scheduled LCM. The indication to transmit data requires the serving AP to perform one of: (1) switching to the HCM when the serving AP is operating in the LCM, or (2) extending the HCM during the scheduled LCM when the serving AP is operating in the HCM. The method comprises identifying (1404), in response to the received indication to transmit data, a neighboring AP among one or more neighboring APs, based on pre-established coordination information exchanged among the serving AP and the one or more neighboring APs. The identified neighboring AP is operating in the HCM. The method comprises performing (1406) a redirection procedure to the identified neighboring AP, to offload the associated client device and serve the received indication to transmit data.

Accordingly, the present disclosure provides various advantages. For example, the present disclosure highlights the negative impact of ad-hoc interruptions for serving higher priority traffic on AP’s capability mode. Further, the present disclosure identifies the impact on AP power consumption due to forced movement from LCM to HCM. The present disclosure further identifies the impact on AP power consumption due to the forced extension of the current HCM. The present disclosure uses cross-AP information available via MAPC schemes to avoid forced transition of the operating mode of the AP. The present disclosure also discloses techniques to handle the interrupting associated client devices more efficiently by offloading the associated client devices to an appropriate neighbor AP able to serve the required QoS. The present disclosure also discloses techniques to avoid the capability mode interrupting events, thus saving power for the AP.

In this disclosure, unless specifically stated otherwise, the use of the singular includes the plural, and the use of "or" may refer to "and/or." Furthermore, the use of the terms "including" or "having" is not limiting. Any range described herein will be understood to include the endpoints and all values between the endpoints. Features of the disclosed embodiments/examples may be combined, rearranged, omitted, etc., within the scope of the disclosure to produce additional embodiments/examples. Furthermore, certain features may sometimes be used to advantage without a corresponding use of other features.

While various example embodiments been presented in the foregoing detailed description, it should be appreciated that a vast number of variations exist. It will also be understood that any of the embodiment(s) described herein may be used in conjunction with any other embodiment(s) described herein.

What is claimed is:

1. A client device, the client device comprising:
at least one processor comprising processing circuitry; and
memory storing instructions, when executed by the at least one processor individually or collectively, cause the client device to:
transmit, to a serving access point (AP) operating in one of a Low Capability Mode (LCM) or a High Capability Mode (HCM) with a scheduled LCM, an indication to transmit data, wherein the indication to transmit data requires the serving AP to perform one of:
switching to the HCM based on the serving AP operating in the LCM; or
extending the HCM during the scheduled LCM based on the serving AP operating in the HCM; and
receive, from the serving AP, a redirect notify message in response to the transmitted indication to transmit data, wherein the redirect notify message directs the client device to re-associate with a neighboring AP.

2. The client device of claim 1, the instructions, when executed by the at least one processor individually or collectively, cause the client device to:
save beacon or unsolicited probe response information of the neighboring AP at the client device.

3. The client device of claim 1, the instructions, when executed by the at least one processor individually or collectively, cause the client device to:
transmit a redirect request message to the neighboring AP in response to receiving the redirect notify message, wherein the redirect request message comprises a request to initiate a data handover session with the neighboring AP.

4. The client device of claim 3, the instructions, when executed by the at least one processor individually or collectively, cause the client device to:
receive, from the neighboring AP, a redirect response message in response to the transmitted redirect request message, wherein the redirect response message indicates at least a confirmation of the data handover session.

5. A serving access point (AP), the serving AP comprising:
at least one processor comprising processing circuitry; and
memory storing instructions, that, when executed by the at least one processor individually or collectively, cause the serving AP to:
receive, from a client device associated with the serving AP, an indication to transmit data, wherein the serving AP is operating in one of a Low Capability Mode (LCM) or a High Capability Mode (HCM) with a scheduled LCM, and wherein the indication to transmit data requires the serving AP to perform one of:
switch to the HCM based on the serving AP operating in the LCM; or
extend the HCM during the scheduled LCM based on the serving AP operating in the HCM;
identify, in response to receiving the indication to transmit data, a neighboring AP among one or more neighboring APs, based on established coordination information exchanged among the serving AP and the one or more neighboring APs, wherein the neighboring AP is operating in the HCM; and
perform a redirection procedure to the identified neighboring AP, to offload the associated client device and serve the received indication to transmit data.

6. The serving AP of claim 5, wherein, to perform the redirection procedure, the instructions, when executed by the at least one processor individually or collectively, cause the serving AP to:
transmit, to the identified neighboring AP, a redirect indication message;
receive, from the identified neighboring AP, a redirect confirmation message in response to the transmitted redirect indication message; and
transmit, to the client device, a redirect notify message indicating the client device to re-associate with the identified neighboring AP and transmit the data to the identified neighboring AP, in response to the receiving the redirect confirmation message.

7. The serving AP of claim 6, wherein the redirect indication message includes at least one of: a coordination group identifier, a reason code for redirection, or information associated with the associated client device.

8. The serving AP of claim 6, wherein the redirect confirmation message includes at least one of a coordination group identifier or a response to the redirect indication message.

9. The serving AP of claim 6, wherein the redirect notify message includes at least one of: a neighbor ID associated with the identified neighbouring AP, available link information of the identified neighbouring AP, or a timing of broadcasting a beacon of the identified neighbouring AP.

10. The serving AP of claim 5, wherein in response to a successful redirection procedure, the instructions, when executed by the at least one processor individually or collectively, cause the serving AP to:
perform one of:
continue the LCM; or
switch to the scheduled LCM upon expiry of a specified time period associated with the HCM.

11. The serving AP of claim 5, wherein the instructions, when executed by the at least one processor individually or collectively, cause the serving AP to:
perform the redirection procedure within a transition time, wherein the transition time is less than a specified threshold.

12. The serving AP of claim 5, wherein in response to a successful redirection procedure, the instructions, when executed by the at least one processor individually or collectively, cause the serving AP to:
transmit current data session context of the associated client device to the identified neighboring AP, wherein the current data session context includes at least one of: a Sequence Number (SN) associated with a current data session, a Packet Number (PN) per Traffic Identifier (TID) associated with the current data session, a Block Acknowledgement (BA) agreement associated with the current data session, or security keys associated with the current data session.

13. The serving AP of claim 5, the instructions, when executed by the at least one processor individually or collectively, cause the serving AP to:
pre-authenticate the client device with at least one AP from among the one or more neighboring APs.

14. The serving AP of claim 5, wherein the serving AP and the one or more neighboring APs are part of a group of trusted APs.

15. The serving AP of claim 5, the instructions, when executed by the at least one processor individually or collectively, cause the serving AP to:
process a redirect indication message and a redirect confirmation message between the serving AP and potential neighboring APs among the one or more neighboring APs before receiving the indication to transmit data.

16. The serving AP of claim 5, the instructions, when executed by the at least one processor individually or collectively, cause the serving AP to:
identify the neighboring AP from among the one or more neighboring APs based on a current operating configuration of the neighboring AP, current load of the neighboring AP and traffic requirements of the associated client device.

17. The serving AP of claim 5, wherein the established coordination information includes a Negotiated Power-saving Profile (NPP) shared among the one or more neighboring APs.

18. The serving AP of claim 17, wherein the NPP comprises at least one of: a power saving duration associated with each of the APs among the one or more neighboring APs, a power saving scheme associated with each of the APs among the one or more neighboring APs, or radio/physical layer capabilities associated with each of the APs among the one or more neighboring APs.

19. A method performed by a client device in a wireless network, the method comprising:
transmitting, to a serving access point (AP) operating in one of a Low Capability Mode (LCM) or a High Capability Mode (HCM) with a scheduled LCM, an indication to transmit data, wherein the serving AP is associated with the client device, wherein the indication to transmit data requires the serving AP to perform one of:
switching to the HCM based on the serving AP operating in the LCM; or
extending the HCM during the scheduled LCM based on the serving AP operating in the HCM; and
receiving, from the serving AP, a redirect notify message in response to the transmitted indication to transmit data, wherein the redirect notify message directs the associated client device to re-associate with a neighboring AP.

20. The method of claim 19, further comprising:
saving beacon or unsolicited probe response information of the neighboring AP at the associated client device.
